(19) United States
(12) Patent Application Publication
(10) Pub. No.: US 2001/0050959 A1
(43) Pub. Date: Dec. 13, 2001

(54) Encoder and communication device

(76) Inventors: Kosuke Nishio, Osaka (JP); Takashi Katayama, Osaka (JP); Masaharu Matsumoto, Osaka (JP); Akihisa Kawamura, Osaka (JP); Takeshi Fujita, Osaka (JP); Masahiro Sueyoshi, Osaka (JP); Kazutaka Abe, Osaka (JP)

Correspondence Address: Michael K. Kelly, Snell & Wilmer, LLP, One Arizona Center, 400 East Van Buren Street, Phoenix, AZ, 85004-2202, US

(21) Appl. No.: 09/823,728

(22) Filed: Mar. 30, 2001

(30) Foreign Application Priority Data
Mar. 30, 2000 (JP) 2000-095931
Aug. 25, 2000 (JP) 2000-256512

(51) Int. Cl. H04B 14/04

(52) U.S. Cl. 375/243

(57) ABSTRACT

An encoder comprises an input device for sampling an input signal at predetermined time intervals to obtain sampled data on a temporal axis, a conversion device for converting the sampled data on the temporal axis to spectral data on a frequency axis, a quantization device for quantizing the spectral data on the frequency axis, and an output device for outputting a resultant value of quantization as an encoded bit stream. The quantization device comprises an expected-value-of-quantization adjustment portion for determining an expected value of quantization for a specific sub-band on the frequency axis, and a quantization portion for determining a quantization coefficient for the specific sub-band, and quantizing each of a plurality of spectral data contained in the specific sub-band using the quantization coefficient for the specific sub-band. The quantization coefficient for the specific sub-band is determined so that a resultant value of quantization obtained by quantizing one spectral data selected from the plurality of spectral data contained in the specific sub-band, using the quantization coefficient for the specific sub-band, is substantially equal to the expected value of quantization for the specific sub-band.

### BACKGROUND OF THE INVENTION

1. Field of the Invention

The present invention relates to an encoder for receiving an input signal and outputting an encoded bit stream, and a communication device including the encoder.

2. Description of the Related Art

To date, various techniques for compression-encoding audio data have been developed. Among such techniques is “MPEG-2 Advanced Audio Coding” (hereinafter referred to as AAC).

The details of AAC are described in a specification titled “ISO 13818-7 (MPEG-2 Advanced Audio Coding, AAC)”.

According to AAC: a digital audio signal, or input signal, is sampled at predetermined time intervals; the sampled data on the temporal axis is converted to spectral data on the frequency axis; the spectral data on the frequency axis is quantized; and the result of the quantization is output as an encoded bit stream.

Hereinafter, a quantization formula and algorithm used in AAC will be described.

The quantization formula is represented by:

$$xQuant = ( int ) ( {( ( abs ) {mdct}_{—} line \times {2}^{\frac{scalefactor - {common}_{–} scalefac}{4}} )}^{\frac{3}{4}} + {MAGIC}_{—} NUMBER ) . \qquad ( 1 )$$

where xQuant represents a result of quantization, mdct_line represents a spectral data value on the frequency axis, scalefactor represents a quantization coefficient defined by each scalefactor band, common_scalefac represents a quantization coefficient common to each scale factor band, and MAGIC_NUMBER is a constant equal to 0.4054.

A plurality of spectral data on the frequency axis is classified to a plurality of groups. Each group includes at least one spectral data. For example, the number of spectral data on the frequency axis is 1024, and the number of groups is 49. The term “data” herein means a singlular datum and/or a plurality of datums, and also means a data value and/or data values.

Each group is herein referred to as a “scale factor band” or “sub-band”.

FIG. 15 shows a conventional quantization procedure. Hereinafter, the steps of the conventional quantization procedure will be described.

Step S601: for each sub-band, scalefactor is set to an initial value, e.g., zero.

Step S602: common_scalefactor is set to an initial value. The initial value is represented by start_common_scalefac.

In AAC, the maximum value of xQuant is 8191. The value of start_common_scalefac is designed so that the value of xQuant does not exceed 8191 when the value of scalefactor is zero.

Step S603: mdct_line is quantized using scalefactor and common_scalefac. As a result, xQuant is obtained. In this quantization, above quantization formula (1) is used.

Step S604: quantization cost is calculated based on xQuant. The term “quantization cost” means the number of bits required for transmission or accumulation of a result of quantization.

Step S605: it is determined whether the quantization cost calculated in step S604 exceeds an allowable value. When the determination in step S605 is “Yes”, the value of common_scalefac is increased (step S606) and the process returns to step S603. When the determination in step S605 is “No”, the process moves to step S607.

Step S607: xQuant is inversely quantized using scalefactor and common_scalefac. The resultant value is represented by inv_mdct_line.

Step S608: quantization noise is calculated, and it is determined whether the quantization noise exceeds an allowable value. The quantization noise is the sum of a power of a difference (error) between mdct_line and inv_mdct_line for the spectral data of each sub-band. In AAC, an allowable value for the quantization noise is, for example, a “threshold value of noise due to a quantization error below which a human ear cannot hear” calculated using a psychoacoustic model.

For each sub-band, when the determination in step S608 is “Yes”, the value of the corresponding scalefactor is increased (step S609). When there is at least one “Yes”, the process returns to step S603. When the determination in step S608 is “No” for all sub-bands, the process ends.

By the above-described quantization, scalefactor, common_scalefac, and xQuant are output.

FIG. 16 shows a conventional quantization apparatus 1510 which is operated in accordance with the conventional procedure shown in FIG. 15.

The quantization apparatus 1510 comprises: a quantization coefficient adjustment portion 1531 for adjusting quantization coefficients (scalefactor and common_scalefac); a quantization portion 1541 for quantizing spectral data (mdct_line) contained in each sub-band; and a determination portion 1551 for performing inverse quantization to determine quantization noise and quantization cost.

FIG. 17 shows a data flow in the conventional quantization portion 1541. The quantization portion 1541 performs step S603 of the procedure of FIG. 15, i.e., quantization of spectral data (mdct_line) using the quantization formula (1) and the quantization coefficients (scalefactor and common_scalefac) to obtain a value of an equlization result (xQuant).

Generally, as the value of xQuant is increased, a group of a plurality of spectral data within the same sub-band can be more exactly reproduced. Therefore, the greater the value of xQuant, the higher the audio quality maintained.

When an audio bit stream is transmitted or accumulated at a low bit rate, the number of bits may be insufficient for allocation of the audio bit stream. As a result, the value of xQuant is considerably small in the conventional quantization algorithm. Therefore, in the conventional quantization algorithm, high audio quality is not likely to be maintained in the case of transmission or accumulation of an audio bit stream at a low bit rate.

For example, when the average transmission rate is 64 Kbps/ch, the number of bands (sub-bands) for which the value of xQuant is 1 or 2 is increased. As a result, quantization noise is increased. Alternatively, due to the insufficient number of bits, an increase in the value of common_scalefac may cause a band to have a zero value of xQuant. In such a band, audio data is not transmitted.

According to the above-described reasons, audio quality is significantly deteriorated at a low bit rate.

### SUMMARY OF THE INVENTION

According to one aspect of the present invention, an encoder comprises an input device for sampling an input signal at predetermined time intervals to obtain sampled data on a temporal axis, a conversion device for converting the sampled data on the temporal axis to spectral data on a frequency axis, a quantization device for quantizing the spectral data on the frequency axis, and an output device for outputting a resultant value of quantization as an encoded bit stream. The quantization device comprises an expected-value-of-quantization adjustment portion for determining an expected value of quantization for a specific sub-band on the frequency axis, and a quantization portion for determining a quantization coefficient for the specific sub-band, and quantizing each of a plurality of spectral data contained in the specific sub-band using the quantization coefficient for the specific sub-band. The quantization coefficient for the specific sub-band is determined so that a resultant value of quantization obtained by quantizing one spectral data selected from the plurality of spectral data contained in the specific sub-band, using the quantization coefficient for the specific sub-band, is substantially equal to the expected value of quantization for the specific sub-band.

In one embodiment of this invention, the quantization portion may comprise a first quantization portion for obtaining a resultant value of quantization by quantizing the selected one spectral data, a quantization coefficient determination portion for determining the quantization coefficient for the specific sub-band, and a second quantization portion for quantizing each of the plurality of spectral data contained in the specific sub-band, using the quantization coefficient for the specific sub-band. The quantization coefficient determination portion may modify an initial value of the quantization coefficient by a predetermined amount to obtain at least one quantization coefficient, and compares at least one resultant value of quantization obtained by the first quantization portion using the at least one quantization coefficient with the expected value of quantization for the specific sub-band, and determines a quantization coefficient so that a resultant value of quantization is substantially equal to the expected value of quantization. The expected-value-of-quantization adjustment portion may adjust the expected value of quantization for the specific sub-band depending on a number of bits which can be allocated for the encoded bit stream.

In one embodiment of this invention, when for a plurality of quantization coefficients, the resultant value of quantization is equal to the expected value of quantization, the quantization coefficient determination portion may select one of the plurality of quantization coefficients so as to obtain a minimum of quantization noise, and may determine the selected quantization coefficient as a quantization coefficient for the specific sub-band.

In one embodiment of this invention, the quantization noise may be calculated based on a difference between the selected one spectral data contained in the specific sub-band and an inverse quantization value obtained by inversely quantizing the resultant value of quantization.

In one embodiment of this invention, the quantization noise may be calculated based on a difference between each spectral data contained in the specific sub-band and an inverse quantization value obtained by inversely quantizing a result of quantization of each spectral data in the specific sub-band.

In one embodiment of this invention, the selected one spectral data may be the largest spectral data contained in the specific sub-band.

According to another aspect of the present invention, the quantization portion may determine the quantization coefficient for the specific sub-band based on a predetermined relationship among a quantization coefficient, a resultant value of quantization, and an inverse quantization value, and based on the relationship, quantizes each of the plurality of spectral data contained in the specific sub-band using the quantization coefficient for the specific sub-band. The quantization coefficient for the specific sub-band may be determined so that an inverse quantization value obtained by inversely quantizing the expected value of quantization for the specific sub-band using the quantization coefficient for the specific sub-band is substantially equal to the selected one spectral data.

In one embodiment of this invention, the predetermined relationship may be defined in a first inverse quantization value table defining a relationship between a quantization coefficient and an inverse quantization value when a resultant value of quantization is predetermined, and a second inverse quantization value table defining a relationship between a resultant value of quantization and an inverse quantization value when a quantization coefficient is predetermined.

In one embodiment of this invention, the quantization portion may generate, based on the first and second inverse quantization value tables, a relationship between a quantization coefficient and an inverse quantization value when a resultant value of quantization is different from the predetermined resultant value of quantization, or a relationship between a resultant value of quantization and an inverse quantization value when a quantization coefficient is different from the predetermined quantization coefficient.

In one embodiment of this invention, an inverse quantization value on the first inverse quantization value table may be represented by an inverse of said inverse quantization value.

In one embodiment of this invention, an inverse quantization value on the second inverse quantization value table may be represented by an inverse of said inverse quantization value.

In one embodiment of this invention, the expected-value-of-quantization adjustment portion determines the expected value of quantization for the specific sub-band based on the plurality of spectral data contained in the specific sub-band.

In one embodiment of this invention, the expected-value-of-quantization adjustment portion may set the expected value of quantization for the specific sub-band to a predetermined value.

In one embodiment of this invention, the quantization coefficient for the specific sub-band may be determined so that an inverse quantization value obtained by inversely quantizing the expected value of quantization for the specific sub-band using the quantization coefficient for the specific sub-band is not smaller than the selected one spectral data.

In one embodiment of this invention, the quantization coefficient for the specific sub-band may be determined so that an inverse quantization value obtained by inversely quantizing the expected value of quantization for the specific sub-band using the quantization coefficient for the specific sub-band is not greater than the selected one spectral data.

In one embodiment of this invention, the quantization coefficient for the specific sub-band may be selected from first and second quantization coefficients based on a predetermined condition, an inverse quantization value obtained by inversely quantizing the expected value of quantization for the specific sub-band using the first quantization coefficient for the specific sub-band may not necessarily be greater than the selected one spectral data, is and an inverse quantization value obtained by inversely quantizing the expected value of quantization for the specific sub-band using the second quantization coefficient for the specific sub-band may not necessarily be smaller than the selected one spectral data.

According to another aspect of the present invention, an encoder comprises an input device for sampling an input signal at predetermined time intervals to obtain sampled data on a temporal axis, a conversion device for converting the sampled data on a temporal axis to spectral data on a frequency axis, a quantization device for quantizing the spectral data on the frequency axis, and an output device for outputting a resultant value of quantization as an encoded bit stream. The quantization device comprises a quantization coefficient adjustment portion for determining a quantization coefficient for a specific sub-band on the frequency axis, and a quantization portion for determining a resultant value of quantization for each of the plurality of spectral data contained in the specific sub-band, based on a predetermined relationship between a quantization coefficient, a resultant value of quantization, and an inverse quantization value.

In one embodiment of this invention, the predetermined relationship may be defined in a first inverse quantization value table defining a relationship between a quantization coefficient and an inverse quantization value when a resultant value of quantization is predetermined, and a second inverse quantization value table defining a relationship between a resultant value of quantization and an inverse quantization value when a quantization coefficient is predetermined.

In one embodiment of this invention, the quantization portion may generate, based on the first and second inverse quantization value tables, a relationship between a quantization coefficient and an inverse quantization value when a resultant value of quantization is different from the predetermined resultant value of quantization, or a relationship between a resultant value of quantization and an inverse quantization value when a quantization coefficient is different from the predetermined quantization coefficient.

In one embodiment of this invention, an inverse quantization value on the first inverse quantization value table may be represented by an inverse of said inverse quantization value.

In one embodiment of this invention, an inverse quantization value on the second inverse quantization value table may be represented by an inverse of said inverse quantization value.

In one embodiment of this invention, a resultant value of quantization for each of the plurality of spectral data contained in the specific sub-band may be determined so that an inverse quantization value obtained by inversely quantizing the resultant value of quantization for each of the plurality of spectral data contained in the specific sub-band, using the quantization cofficient for the specific sub-band, is substantially equal to the each of the plurality of spectral data contained in the specific sub-band.

In one embodiment of this invention, a resultant value of quantization for each of the plurality of spectral data contained in the specific sub-band may be determined so that an inverse quantization value obtained by inversely quantizing the resultant value of quantization for each of the plurality of spectral data, using the quantization cofficient for the specific sub-band, is not smaller than the each of the plurality of spectral data.

In one embodiment of this invention, a resultant value of quantization for each of the plurality of spectral data contained in the specific sub-band may be determined so that an inverse quantization value obtained by inversely quantizing the resultant value of quantization for each of the plurality of spectral data, using the quantization cofficient for the specific sub-band, is not greater than the each of the plurality of spectral data.

In one embodiment of this invention, the resultant value of quantization for a specific spectral data of the plurality of spectral data contained in the specific sub-band may be selected from first and second resultant values of quantization based on a predetermined condition, an inverse quantization value obtained by inversely quantizing the first resultant value of quantization using the quantization coefficient for the specific sub-band may not necessarily be greater than the specific spectral data, and an inverse quantization value obtained by inversely quantizing the second resultant value of quantization using the quantization coefficient for the specific sub-band may not necessarily be smaller than the specific spectral data.

According to another aspect of the present invention, an encoder comprises an input device for sampling an input signal at predetermined time intervals to obtain sampled data on a temporal axis, a conversion device for converting the sampled data on the temporal axis to spectral data on a frequency axis, a quantization device for quantizing the spectral data on the frequency axis, and an output device for outputting a resultant value of quantization as an encoded bit stream. The quantization device comprises an expected-value-of-quantization adjustment portion for determining an expected value of quantization for a specific sub-band on the frequency axis, and a first quantization portion for determining an initial value of a quantization coefficient for the specific sub-band, based on a predetermined relationship among a quantization coefficient, a resultant value of quantization, and an inverse quantization value, a quantization coefficient adjustment portion for determining the quantization coefficient for the specific sub-band, and a second quantization portion for quantizing each of the plurality of spectral data contained in the sepcific sub-band using the quantization coefficient for the specific sub-band. The first quantization portion determines the initial value of the quantization coefficient so that a resultant value of quantization obtained by quantizing one spectral data selected from the plurality of spectral data contained in the specific sub-band, using the initial value for the specific sub-band, is substantially equal to the expected value of quantization for the specific sub-band. The quantization coefficient adjustment portion adjusts the quantization coefficient for the specific sub-band so that quantization noise is not greater than qantization noise which is obtained when each of the plurality of spectral data contained in the specific sub-band is quantized using the initial value.

In one embodiment of this invention, the second quantization portion may quantize each of the plurality of spectral data contained in the specific sub-band using the quantization coefficient for the specific sub-band, based on a predetermined relationship among a quantization coefficient, a resultant value of quantization, and an inverse quantization value.

In one embodiment of this invention, the predetermined relationship may be defined in a first inverse quantization value table defining a relationship between a quantization coefficient and an inverse quantization value when a resultant value of quantization is predetermined, and a second inverse quantization value table defining a relationship between a resultant value of quantization and an inverse quantization value when a quantization coefficient is predetermined.

In one embodiment of this invention, the first quantization portion may generate, based on the first and second inverse quantization value tables, a relationship between a quantization coefficient and an inverse quantization value when a resultant value of quantization is different from the predetermined resultant value of quantization, or a relationship between a resultant value of quantization and an inverse quantization value when a quantization coefficient is different from the predetermined quantization coefficient.

In one embodiment of this invention, the expected-value-of-quantization adjustment portion may determine the expected value of quantization for the specific sub-band based on the plurality of spectral data contained in the specific sub-band.

In one embodiment of this invention, the expected-value-of-quantization adjustment portion may set the expected value of quantization for the specific sub-band to a predetermined value.

According to another aspect of the present invention, a program is provided for causing a computer to executing an encoding process for outputting an input signal as an encoded bit stream. The encoding process comprises the steps of (a) sampling an input signal at predetermined time intervals to obtain sampled data on a temporal axis, (b) converting the sampled data on the temporal axis to spectral data on a frequency axis, (c) quantizing the spectral data on the frequency axis, and (d) outputting a resultant value of quantization as an encoded bit stream. The step (c) comprises (c-1) determining an expected value of quantization for a specific sub-band on the frequency axis, and (c-2) determining a quantization coefficient for the specific sub-band, and quantizing each of a plurality of spectral data contained in the specific sub-band using the quantization coefficient for the specific sub-band. The step (c-2) comprises the step of determining the quantization coefficient for the specific sub-band so that a resultant value of quantization obtained by quantizing one spectral data selected from the plurality of spectral data contained in the specific sub-band, using the quantization coefficient for the specific sub-band, is substantially equal to the expected value of quantization for the specific sub-band.

According to another aspect of the present invention, a computer-readable recording medium is provided for storing an encoding process program for outputting an input signal as an encoded bit stream. The encoding process comprises the steps of (a) sampling an input signal at predetermined time intervals to obtain sampled data on a temporal axis, (b) converting the sampled data on the temporal axis to spectral data on a frequency axis, (c) quantizing the spectral data on the frequency axis, and (d) outputting a resultant value of quantization as an encoded bit stream. The step (c) comprises (c-1) determining an expected value of quantization for a specific sub-band on the frequency axis, and (c-2) determining a quantization coefficient for the specific sub-band, and quantizing each of a plurality of spectral data contained in the specific sub-band using the quantization coefficient for the specific sub-band. The step (c-2) comprises the step of determining the quantization coefficient for the specific sub-band so that a resultant value of quantization obtained by quantizing one spectral data selected from the plurality of spectral data contained in the specific sub-band, using the quantization coefficient for the specific sub-band, is substantially equal to the expected value of quantization for the specific sub-band.

According to another aspect of the present invention, a communication device comprises a demodulator for obtaining digital audio data by demodulating an input signal, an encoder for obtaining an encoded bit stream by encoding the digital audio data, and a recorder for recording the encoded bit stream into a recording medium. The encoder comprises an input device for sampling the digital audio data at predetermined time intervals, a conversion device for converting the sampled data on the temporal axis to spectral data on the frequency axis, a quantization device for quantizing the spectral data on the frequency axis, and an output device for outputting a resultant value of quantization as the encoded bit stream. The quantization device comprises an expected-value-of-quantization adjustment portion for determining an expected value of quantization for a specific sub-band on the frequency axis, a quantization portion for determining a quantization coefficient for the specific sub-band, and quantizing each of a plurality of spectral data contained in the specific sub-band using the quantization coefficient for the specific sub-band. The quantization coefficient for the specific sub-band is determined so that a resultant value of quantization obtained by quantizing one spectral data selected from the plurality of spectral data contained in the specific sub-band, using the quantization coefficient for the specific sub-band, is substantially equal to the expected value of quantization for the specific sub-band.

Thus, the invention described herein makes possible the advantages of providing an encoder which allows low-bit rate data transmission or accumulation while maintaining a high quality of data, and a communication device including such an encoder.

These and other advantages of the present invention will become apparent to those skilled in the art upon reading and understanding the following detailed description with reference to the accompanying figures.

### BRIEF DESCRIPTION OF THE DRAWINGS

FIG. 1 is a diagram showing a configuration of an encoder 100 according to Example 1 of the present invention.

FIG. 2 is a block diagram showing a configuration of a quantization device 130 shown in FIG. 1.

FIG. 3 is a diagram showing an exemplary correspondence among spectral data (mdct_line), a quantization coefficient (SCALEFACTOR), a resultant value of quantization (xQuant), and an inverse quantization value (inv_mdct_line).

FIG. 4 is a block diagram showing a configuration of a quantization device 230.

FIGS. 5A and 5B are diagrams showing a flow of data in a quantization portion 232.

FIG. 5C is a diagram showing a flow of data in a quantization portion 332.

FIG. 6 is a diagram showing a first inverse quantization value table contained in an inverse quantization value table 234.

FIG. 7 is a diagram showing a second inverse quantization value table contained in an inverse quantization value table 234.

FIG. 8 is a diagram showing a second inverse quantization value table 234b′ in which an inverse quantization value is represented by an inverse of that value.

FIG. 9 is a block diagram showing a configuration of a quantization device 1130 according to Example 3 of the present invention.

FIG. 10 is a block diagram showing a configuration of a quantization device 2130 according to Example 4 of the present invention.

FIG. 11 is a block diagram showing a configuration of a quantization device 1230.

FIG. 12 is a flowchart showing a quantization procedure executed by the quantization device 1230.

FIG. 13 is a flowchart showing a procedure of adjustment (step S401 in FIG. 12) of a quantization coefficient (SCALEFACTOR).

FIG. 14 is a block diagram showing a configuration of a communication device 800 including the encoder of the present invention.

FIG. 15 is a flowchart showing a conventional quantization procedure.

FIG. 16 is a block diagram showing a configuration of a conventional quantization device 1510 which is operated in accordance with the conventional procedure shown in FIG. 15.

FIG. 17 is a diagram showing a flow of data in a quantization portion 1541 in a conventional technology.

### DESCRIPTION OF THE PREFERRED EMBODIMENTS

Hereinafter, the present invention will be described by way of illustrative examples with reference to the accompanying drawings.

All Examples of the present invention use a quantization formula represented by:

$$xQuant = ( int ) ( {( ( abs ) {mdct}_{—} line )}^{\frac{3}{4}} \times {2}^{\frac{3}{16} \times SCALEFACTOR} + {MAGIC}_{—} NUMBER ) \qquad ( 2 )$$

which is a variation of the above quantization formula (1), where SCALEFACTOR=scalefactor−common_scalefac. Hereinafter, SCALEFACTOR is called a “quantization coefficient”. A quantization coefficient is determined for each sub-band on the frequency axis.

Note that the present invention is not limited to an encoding technique using the quantization formula (2). The present invention can also be widely applied to an encoding technique using a quantization formula represented by:

xQuant=F(mdct_{—}line, SCALEFACTOR) (3)

where F is an arbitrary function having mdct_line and SCALEFACTOR as variables. For example, the present invention may be applied to an encoding technique, such as “MPEG-1, Layer 3 (MP3)”.

Hereinafter, an encoder for encoding audio data (digital audio data) will be described as an example of the present invention. However, data which is subjected to encoding by an encoder according to the present invention is not limited to a specific type of data. The present invention can be applied to an encoder for encoding an arbitrary data type, such as image data.

### EXAMPLE 1

In Example 1, an expected value of quantization is given to a specific sub-band on the frequency band. One spectral data is selected from a plurality of spectral data contained in the specific sub-band, and the selected spectral data is subjected to quantization. In this case, a quantization coefficient for the specified sub-band is determined so that the resultant value of the quantization is substantially equal to the expected value of quantization. Similarly, quantization coefficients are determined for all sub-bands on the frequency axis. The expected value of quantization is adjusted depending on the number of bits which can be allocated for an encoded bit stream.

When a quantization coefficient is determined for a specific sub-band in this manner, the resultant value of quantization of one spectral data selected from a plurality of spectral data contained in a specific sub-band is not smaller than the expected value of quantization. Such a situation enables suppression of data quality deterioration.

Note that one spectral data selected from a plurality of spectral data contained in a specific sub-band may be arbitrary spectral data. For example, the selected one spectral data may be the largest spectral data (spectral data having the largest amplitude) among the plurality of spectral data contained in the specific sub-band, or alternatively, the second or third largest spectral data.

It is preferable that one spectral data selected from a plurality of spectral data contained in a specific sub-band may be the largest spectral data among the plurality of spectral data. This is because the resultant value of quantization of the largest spectral data contained in a specific sub-band has the largest influence on data quality as compared to the resultant values of quantization of the other spectral data contained in the specific sub-band.

Further, when a quantization coefficient for a specified sub-band is determined so that the resultant value of quantization of the largest spectral data is substantially equal to the expected value of quantization, the resultant value of quantization of the other spectral data of the plurality of spectral data contained in the specific sub-band may be smaller than the expected value of quantization. However, according to characteristics of a human auditory system, the largest spectral data masks the other spectral data so that a human has difficulty in hearing the other spectral data. The reason is that since the largest spectral data has a frequency close to that of the other spectral data in the same sub-band, even if the resultant value of quantization of spectral data other than the largest spectral data is smaller than the expected value of quantization, a human ear has difficulty in perceiving such a situation as deterioration in data quality. It is therefore preferable that one spectral data selected from a plurality of spectral data contained in a specific sub-band is the largest spectral data among the plurality of spectral data.

Similarly, for all sub-bands on the frequency axis, it can be secured that the resultant value of quantization of one spectral data selected from a plurality of spectral data contained in each sub-band is not smaller than the expected value of quantization. As a result, data quality deterioration can be suppressed.

Further, in Example 1, when a resultant value of quantization is equal to the expected value of quantization for a plurality of quantization coefficients, one quantization coefficient which achieves the minimum quantization noise is selected from the plurality of quantization coefficients, and the selected qantization coefficient is determined as a quantization coefficient for a specified sub-band.

Thus, the selection of a quantization coefficient which achieves the minimum quantization noise leads to a minimization of data quality deterioration.

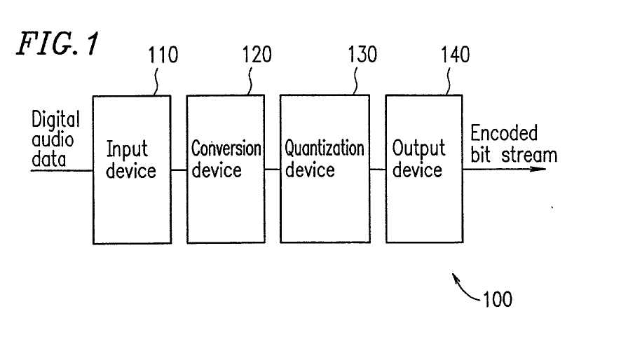

Hereinafter, Example 1 of the present invention will be described with reference to FIGS. 1 through 3.

FIG. 1 shows a configuration of an encoder 100 according to Example 1 of the present invention. The encoder 100 encodes digital audio data in accordance with ACC.

The encoder 100 comprises: an input device 110 for sampling digital audio data, or an input signal, at intervals of a predetermined time; a conversion device 120 for converting the sampled data on the temporal axis to spectral data on the frequency axis; a quantization device 130 for quantizing the spectral data on the frequency axis; and an output device 140 for outputting the resultant value of the quantization as an encoded bit stream.

In AAC, a MDCT (Modified Discrete Cosine Transformation) is used to convert the sampled data on the temporal axis to the spectral data on the frequency axis.

Note that tools may be used for an actual AAC encoder, such as gain control, TNS (Temporal Noise Shaping), a psychoacoustic model, M/S stereo, intensity stereo, and prediction. Further, switching of block sizes, a bit reservoir, and the like may be used. However, the present invention is independent of these technologies which are not, therefore, described herein.

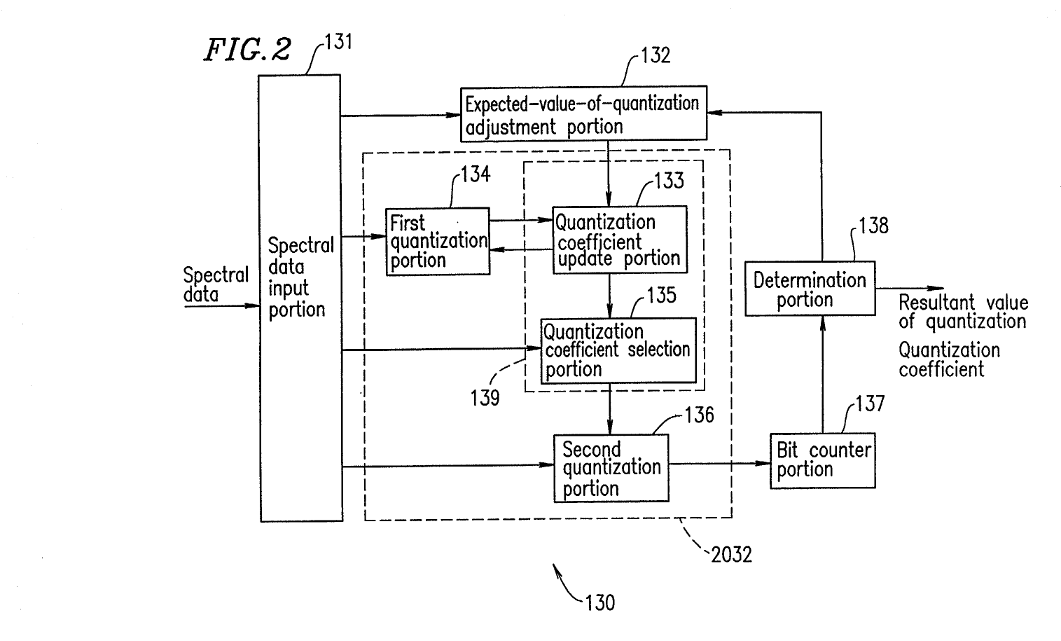

FIG. 2 shows the quantization device 130 of FIG. 1.

A spectral data input portion 131 receives data (spectral data) on the frequency axis from the conversion device 120, samples the data for each sub-band, and outputs the sampled data. The spectral data is successively output in a frequency order from a sub-band in a lowest frequency band. The number of spectral data in each sub-band may differ among sub-bands.

An expected-value-of-quantization adjustment portion 132 receives the spectral data which has been sampled by the spectral data input portion 131 for each sub-band. The expected-value-of-quantization adjustment portion 132 determines the expected value of quantization for each sub-band. The expected value of quantization for each sub-band may be determined depending on the spectral data contained in each sub-band. For example, the expected value of quantization may be determined based on the largest spectral data of a plurality of spectral data in each sub-band, or alternatively, based on the average of all of a plurality of spectral data in each sub-band, or based on the sum of squares of all of a plurality of spectral data in each sub-band. Alternatively, the expected value of quantization for each sub-band may be determined independent of the spectral data contained in each sub-band. The expected-value-of-quantization adjustment portion 132 may determine the same expected value of quantization for all sub-bands based on the largest spectral data contained in a sub-band in the lowest frequency band on the frequency axis. The expected value of quantization is output to a quantization coefficient update portion 133.

Further, the expected value of quantization for each sub-band may be determined so that sufficient audio quality can be obtained, or alternatively, so that a minimum acceptable audio quality can be obtained. Generally, the greater the expected value of quantization, the smaller the quantization noise, thus high audio quality is obtained.

The quantization coefficient update portion 133 calculates an initial value of a quantization coefficient. The initial value of the quantization coefficient is output to a first quantization portion 134.

The first quantization portion 134 quantizes the largest spectral data of a plurality of spectral data contained in a current sub-band output from the spectral data input portion 131 using a quantization coefficient output from the quantization coefficient update portion 133. The result of quantization by the first quantization portion 134 is output as the resultant value of quantization to the quantization coefficient update portion 133.

The quantization coefficient update portion 133 compares the resultant value of quantization output from the first quantization portion 134 with an expected value of quantization output from the expected-value-of-quantization adjustment portion 132. When the resultant value of quantization is greater than the expected value of quantization, the quantization coefficient update portion 133 decreases a quantization coefficient by one. When the resultant value of quantization is smaller than the expected value of quantization, the quantization coefficient update portion 133 increases a quantization coefficient by one. The thus-updated quantization coefficient is output to the first quantization portion 134.

The first quantization portion 134 quantizes the largest spectral data of a plurality of spectral data contained in a current sub-band, using the updated quantization coefficient. The result of quantization by the first quantization portion 134 is output as the resultant value of quantization to the quantization coefficient update portion 133.

The quantization coefficient update portion 133 compares a resultant value of quantization output from the first quantization portion 134 with an expected value of quantization output from the expected-value-of-quantization adjustment portion 132. In this manner, the comparison of a resultant value of quantization with an expected value of quantization is repeated.

The comparison of a resultant value of quantization with an expected value of quantization is continued until the inequality relationship between the resultant value of quantization and the expected value of quantization is reversed by updating a quantization coefficient. When “a resultant value of quantization>an expected value of quantization” is established as an initial value of a quantization coefficient, the quantization coefficient update portion 133 decreases a quantization coefficient by one until “a resultant value of quantization<an expected value of quantization” is established. Conversely, when “a resultant value of quantization<an expected value of quantization” is established as an initial value of a quantization coefficient, the quantization coefficient update portion 133 increases a quantization coefficient by one until “a resultant value of quantization>an expected value of quantization” is established.

Note that when “a resultant value of quantization=an expected value of quantization” is established in the comparison of the resultant value of quantization with the expected value of quantization, the quantization coefficient update portion 133 outputs a quantization coefficient and the resultant value of quantization to a quantization coefficient selection portion 135.

Note that the quantization coefficient update portion 133 may output a quantization coefficient and a resultant value of quantization to the quantization coefficient selection portion 135 when the absolute value of a difference between a resultant value of quantization and an expected value of quantization is smaller than or equal to a predetermined threshold value (i.e., the resultant value of quantization is substantially equal to the expected value of quantization).

In the quantization coefficient selection portion 135, when the quantization coefficient update portion 133 outputs a single quantization coefficient, the quantization coefficient is determined as a quantization coefficient for a current sub-band.

When the quantization coefficient update portion 133 outputs a plurality of quantization coefficients, the quantization coefficient selection portion 135 selects one of the plurality of quantization coefficients which achieves the least quantization noise, and determines the selected quantization coefficient as a quantization coefficient for the current sub-band.

For example, quantization noise is evaluated as the absolute value of a difference between the largest spectral data contained in a current sub-band and spectral data (inverse quantization value) obtained by inversely quantizing the resultant value of quantization of the largest spectral data. Alternatively, the difference itself may be used instead of the absolute value. Thus, a quanization noise is evaluated based on the difference. Alternatively, quantization noise is evaluated based on a difference between spectral data other than the largest spectral data and spectral data (inverse quantization value) obtained by inversely quantizing the resultant value of quantization of that spectral data.

Alternatively, quantization noise is evaluated as the sum of squares of a difference between each spectral data contained in a current sub-band and spectral data obtained by inversely quantizing the resultant value of quantization of that spectral data. Alternatively, the sum of the absolute values of each difference may be used instead of the sum of squares. Thus, quantization noise may be evaluated based on the differences.

As described above, the quantization coefficient update portion 133 and the quantization coefficient selection portion 135 serve as a quantization coefficient determination portion 139 for determining a quantization coefficient for a current sub-band so that a resultant value of quantization is substantially equal to an expected value of quantization.

A quantization coefficient selected by the quantization coefficient selection portion 135 is output to a second quantization portion 136.

The second quantization portion 136 quantizes all of the spectral data contained in a current sub-band, which are received from the spectral data input portion 131, using the quantization coefficient received from the quantization coefficient selection portion 135.

As described above, the first quantization portion 134, the quantization coefficient update portion 133, the quantization coefficient selection portion 135, and the second quantization portion 136 serve as a quantization portion 2032 which determines a quantization coefficient for a specific sub-band and quantizes each of a plurality of spectral data contained in the specific sub-band using a quantization coefficient for the specific sub-band.

At this point, the quantization process for a current sub-band ends.

When the quantization process ends for a current sub-band, the quantization process begins for a subsequent sub-band output from the spectral data input portion 131. In this manner, a similar quantization process is successively repeated until all sub-bands to be transmitted or accumulated are processed.

When the quantization process has been conducted for all sub-bands to be transmitted or accumulated, the second quantization portion 136 outputs the resultant values of quantization corresponding to the respective spectral data and the quantization coefficients corresponding to the respective sub-bands to a bit counter portion 137.

The bit counter portion 137 calculates the number of bits required for data transmission or accumulation, using resultant values of quantization corresponding to respective spectral data and quantization coefficients corresponding to respective sub-bands. The resultant number of bits as well as the resultant values of quantization corresponding to the respective spectral data and the quantization coefficients corresponding to the respective sub-bands are output to a determination portion 138.

The determination portion 138 determines whether the number of bits output from the bit counter portion 137 falls within an allowable range. When it is judged that the number of bits falls within the allowable range, the determination portion 138 outputs resultant values of quantization corresponding to respective spectral data and quantization coefficients corresponding to respective sub-bands to the output device 140 (FIG. 1). When it is judged that the number of bits falls outside the allowable range, the determination portion 138 outputs the result of the determination to the expected-value-of-quantization adjustment portion 132.

The expected-value-of-quantization adjustment portion 132 adjusts an expected value of quantization depending on the determination result received from the determination portion 138. When the number of bits which can be allocated for an encoded bit stream is insufficient, the expected-value-of-quantization adjustment portion 132 sets an expected value of quantization to a smaller value. For example, the expected-value-of-quantization adjustment portion 132 decreases the expected values of quantization by one for all sub-bands. Alternatively, the expected-value-of-quantization adjustment portion 132 may decrease the expected value of quantization by one for sub-bands having quantization noise less than a predetermined value.

When there is an excess in the number of bits which can be allocated for an encoded bit stream, the expected-value-of-quantization adjustment portion 132 sets an expected value of quantization to a greater value. For example, the expected-value-of-quantization adjustment portion 132 increases the expected values of quantization by one for all sub-bands. Alternatively, the expected-value-of-quantization adjustment portion 132 may increase the expected value of quantization by one for sub-bands having quantization noise larger than a predetermined value. When the expected value of quantization is increased for a sub-band having large quantization noise, audio quality is efficiently improved.

By adjusting the expected value of quantization in this way, an expected value of quantization may result in being zero for a certain sub-band. To avoid this, the minimum value of the expected value of quantization is set to one. When the expected value of quantization becomes zero by the adjustment, the zero expected value of quantization is reset to one.

As described above, a resultant value of quantization is assured to be greater than or equal to one by setting an expected value of quantization to greater than or equal to one. This leads to reliable prevention of audio quality deterioration due to a zero resultant value of quantization.

An expected value of quantization adjusted as described above is used as a new expected value of quantization, and the above-described quantization process is repeated until the number of bits required for data transmission or accumulation falls within an allowable range.

The output device 140 outputs an encoded bit stream having a predetermined format, based on resultant values of quantization corresponding to respective spectral data and quantization coefficients corresponding to respective sub-bands. In AAC, the output device 140 performs data packing in accordance with a Huffman coding technique.

Note that each portion 131 through 139 included in the quantization device 130 may be realized by hardware or software. Alternatively, some of the portions 131 through 139 may be realized by hardware, while the other portions 131 through 139 may be realized by software. The same applies to the input device 110, the conversion device 120, and an output device 140 (FIG. 1).

Further, the first quantization portion 134 and the second quantization portion 136 may have the same structure. Therefore, the first quantization portion 134 and the second quantization portion 136 may be provided as a single quantization portion.

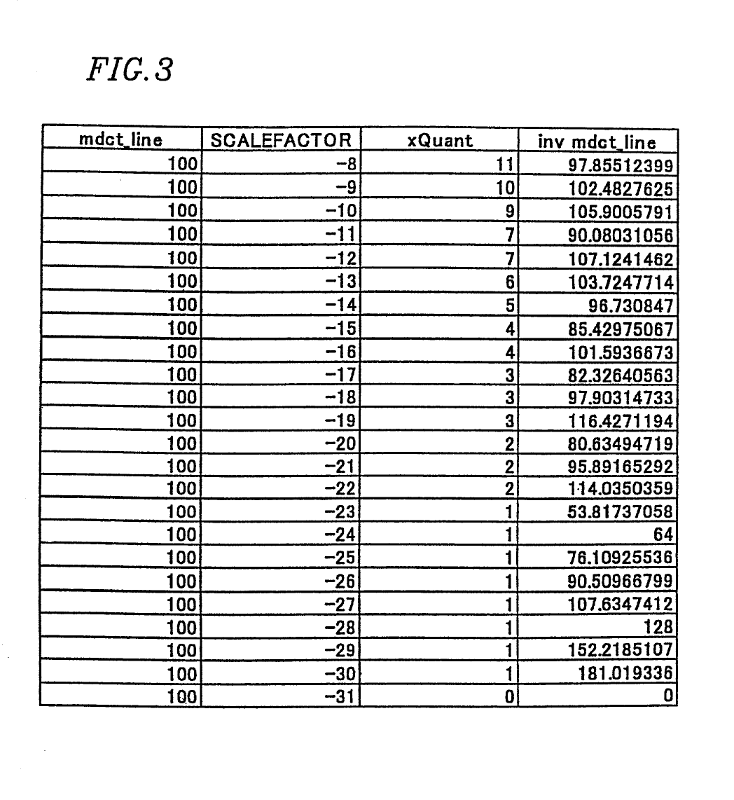

FIG. 3 shows an example of a correspondence among spectral data (mdct_line), a quantization coefficient (SCALEFACTOR), a resultant value of quantization (xQuant), and an inverse quantization value (inv_mdct_line).

xQuant is obtained by substituting mdct_line and SCALEFACTOR into formula (2). The inverse quantization value (inv_mdct_line) is obtained by substituting xQuant and SCALEFACTOR into formula (2). Since 2^{(-3/16)}≅0.878, xQuant is multiplied by a factor of 0.878 when SCALEFACTOR is decreased by one.

Hereinafter, specific examples of operation of the quantization coefficient update portion 133, the first quantization portion 134, and the quantization coefficient selection portion 135 will be described with reference to FIG. 3.

Note that in the example shown in FIG. 3, it is assumed that the largest spectral data of 100 contained in a current sub-band is 100, the expected value of quantization is 3, and the initial value of a quantization coefficient is −10.

The first quantization portion 134 quantizes the largest spectral data of 100 contained in a current sub-band using the initial value −10 of a quantization coefficient. The resultant value of the quantization is 9 as shown in FIG. 3. The resultant value of quantization of 9 is output to the quantization coefficient update portion 133.

Since (the resultant value of quantization of 9)>(the expected value of quantization of 3) is established, the quantization coefficient update portion 133 updates the value of the quantization coefficient so that the value of the quantization coefficient is decreased by one. As a result, the updated value −11 of the quantization coefficient is output to the first quantization portion 134.

The first quantization portion 134 quantizes the largest spectral data of 100 contained in the current sub-band using the updated quantization coefficient of −11. As a result, the resultant value of the quantization of 7 is obtained as shown in FIG. 3. The resultant value of quantization of 7 is output to the quantization coefficient update portion 133.

Since (the resultant value of quantization of 7)>(the expected value of quantization of 3) is established, the quantization coefficient update portion 133 updates the value of the quantization coefficient so that the value of the quantization coefficient is decreased by one. As a result, the updated value −12 of the quantization coefficient is output to the first quantization portion 134.

Similarly, the comparison of a resultant value of quantization with the expected value of quantization is repeated, and the value of the quantization coefficient is decreased by one. As seen from FIG. 3, when the value of the quantization coefficient is −17, the resultant value of quantization of 3 is obtained for that value.

Since (the resultant value of quantization of 3)=(the expected value of quantization of 3) is established, the quantization coefficient update portion 133 outputs the value −17 of the quantization coefficient and the resultant value of quantization of 3 to the quantization coefficient selection portion 135. Further, the quantization coefficient update portion 133 updates the value of the quantization coefficient so that the value of the quantization coefficient is decreased by one. As a result, the updated value −18 of the quantization coefficient is output to the first quantization portion 134.

The first quantization portion 134 quantizes the largest spectral data of 100 contained in the current sub-band using the updated quantization coefficient −18. As a result, the resultant value of the quantization of 3 is obtained as shown in FIG. 3. The resultant value of quantization of 3 is output to the quantization coefficient update portion 133.

Since (the resultant value of quantization 3)=(the expected value of quantization of 3) is established, the quantization coefficient update portion 133 outputs the value −18 of the quantization coefficient and the resultant value of quantization of 3 to the quantization coefficient selection portion 135. Further, the quantization coefficient update portion 133 updates the value of the quantization coefficient so that the value of the quantization coefficient is decreased by one. As a result, the updated value −19 of the quantization coefficient is output to the first quantization portion 134.

The first quantization portion 134 quantizes the largest spectral data of 100 contained in the current sub-band using the updated quantization coefficient −19. As a result, the resultant value of the quantization of 3 is obtained as shown in FIG. 3. The resultant value of quantization of 3 is output to the quantization coefficient update portion 133.

Since (the resultant value of quantization of 3)=(the expected value of quantization of 3) is established, the quantization coefficient update portion 133 outputs the value −19 of the quantization coefficient and the resultant value of quantization of 3 to the quantization coefficient selection portion 135. Further, the quantization coefficient update portion 133 updates the value of the quantization coefficient so that the value of the quantization coefficient is decreased by one. As a result, the updated value −20 of the quantization coefficient is output to the first quantization portion 134.

The first quantization portion 134 quantizes the largest spectral data of 100 contained in the current sub-band using the updated quantization coefficient −20. As a result, the resultant value of the quantization of 2 is obtained as shown in FIG. 3. The resultant value of quantization of 2 is output to the quantization coefficient update portion 133.

Since (the resultant value of quantization of 2)<(the expected value of quantization of 3) is established, the quantization coefficient update portion 133 ends the update process.

The quantization coefficient selection portion 135 holds three sets of outputs from the quantization coefficient update portion 133, i.e., (the value −17 of the quantization coefficient, the resultant value of quantization of 3), (the value −18 of the quantization coefficient, the resultant value of quantization of 3), and (the value −19 of the quantization coefficient, the resultant value of quantization of 3).

The quantization coefficient selection portion 135 inversely quantizes the resultant value of quantization of 3 using the value −17 of the quantization coefficient. As a result, the resultant value about 82.3 of the inverse quantization is obtained as shown in FIG. 3. In this case, the absolute value of the difference between the spectral data of 100 and the resultant value about 82.3 of the inverse quantization is equal to about 17.7.

The quantization coefficient selection portion 135 inversely quantizes the resultant value of quantization of 3 using the value −18 of the quantization coefficient. As a result, the resultant value about 97.9 of the inverse quantization is obtained as shown in FIG. 3. In this case, the absolute value of the difference between the spectral data of 100 and the resultant value about 97.9 of the inverse quantization is equal to about 2.1.

The quantization coefficient selection portion 135 inversely quantizes the resultant value of quantization of 3 using the value −19 of the quantization coefficient. As a result, the resultant value about 116.4 of the inverse quantization is obtained as shown in FIG. 3. In this case, the absolute value of the difference between the spectral data of 100 and the resultant value about 116.4 of the inverse quantization is equal to about 16.4.

According to the results of the above-described calculations, the absolute value of the difference between the spectral data of 100 and the resultant value of the inverse quantization is minimum when the value of the quantization coefficient is −18. Therefore, the quantization coefficient selection portion 135 selects the value −18 of the quantization coefficient, and outputs the value as the value of the quantization coefficient for the current sub-band to the second quantization portion 136.

It is now assumed that all of the spectral data contained in the current sub-band are {100, 100, 100, 100}. In this case, when the sum of squares of the differences between each spectral data and spectral data obtained by inversely quantizing the resultant value of quantization of that spectral data is as follows.

When the value of the quantization coefficient is −17, the sum of squares of the differences is 1253.16.

When the value of the quantization coefficient is −18, the sum of squares of the differences is 17.64.

When the value of the quantization coefficient is −19, the sum of squares of the differences is 1075.84.

According to the results of the above-described calculations, the sum of squares of each spectral data and spectral data obtained by inversely quantizing the resultant value of quantization of that spectral data is minimum when the value of the quantization coefficient is −18. Therefore, the quantization coefficient selection portion 135 may select the value −18 of the quantization coefficient, and output the value as the value of the quantization coefficient for the current sub-band to the second quantization portion 136.

### EXAMPLE 2

In Example 2, an expected value of quantization is given to a specific sub-band on the frequency band. A quantization coefficient for the specified sub-band is determined so that an inverse quantization value obtained by inversely quantizing an expected value of quantization for the specific sub-band on the frequency band is substantially equal to one spectral data selected from a plurality of spectral data contained in the sub-band. The resultant value of quantization obtained by quantizing the one spectral data using the quantization coefficient is substantially equal to the given expected value of quantization. Similarly, a quantization coefficient is determined for each sub-band on the frequency axis. The expected value of quantization is adjusted depending on the number of bits which can be allocated for an encoded bit stream.

When a quantization coefficient is determined for a specific sub-band in this manner, the resultant value of quantization of one spectral data selected from a plurality of spectral data contained in a specific sub-band is substantially equal to the expected value of quantization. That is, the resultant value of quantization can be prevented from being unintentionally small (e.g., zero), thereby enabling suppression of data quality deterioration.

Note that as described in Example 1, one spectral data selected from a plurality of spectral data contained in a specific sub-band may be arbitrary spectral data.

Similarly, for all sub-bands on the frequency axis, it can be secured that the resultant value of quantization of one spectral data selected from a plurality of spectral data contained in each sub-band is substantially equal to the expected value of quantization. As a result, data quality deterioration can be suppressed.

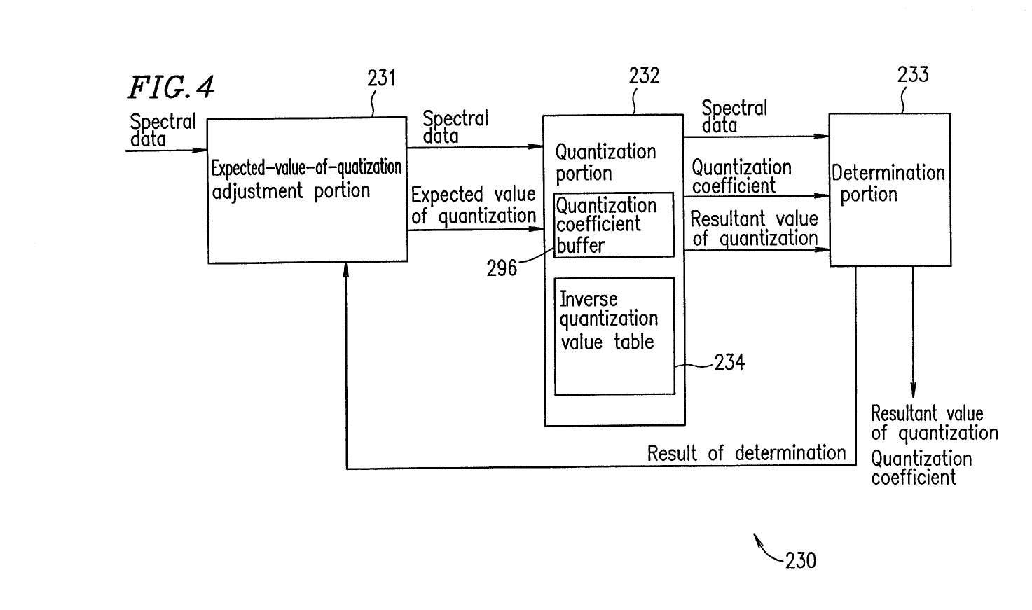

Hereinafter, Example 2 of the present invention will be described with reference to FIGS. 4, 5A, 5B, and 6 through 8.

FIG. 4 shows a configuration of a quantization device 230. The quantization device 230 is used in the encoder 100 of FIG. 1 instead of the quantization device 130. The quantization device 230 comprises: an expected-value-of-quantization adjustment portion 231 for determining the expected value of quantization; a quantization portion 232 for quantizing spectral data; and a determination portion 233 for judging quantization cost and quantization noise. The quantization portion 232 has an inverse quantization value table 234 and a quantization coefficient buffer 296 therein.

The expected-value-of-quantization adjustment portion 231 determines an expected value of quantization in a manner similar to that of the expected-value-of-quantization adjustment portion 132 (FIG. 2). The expected value of quantization determined for each sub-band is output to the quantization portion 232.

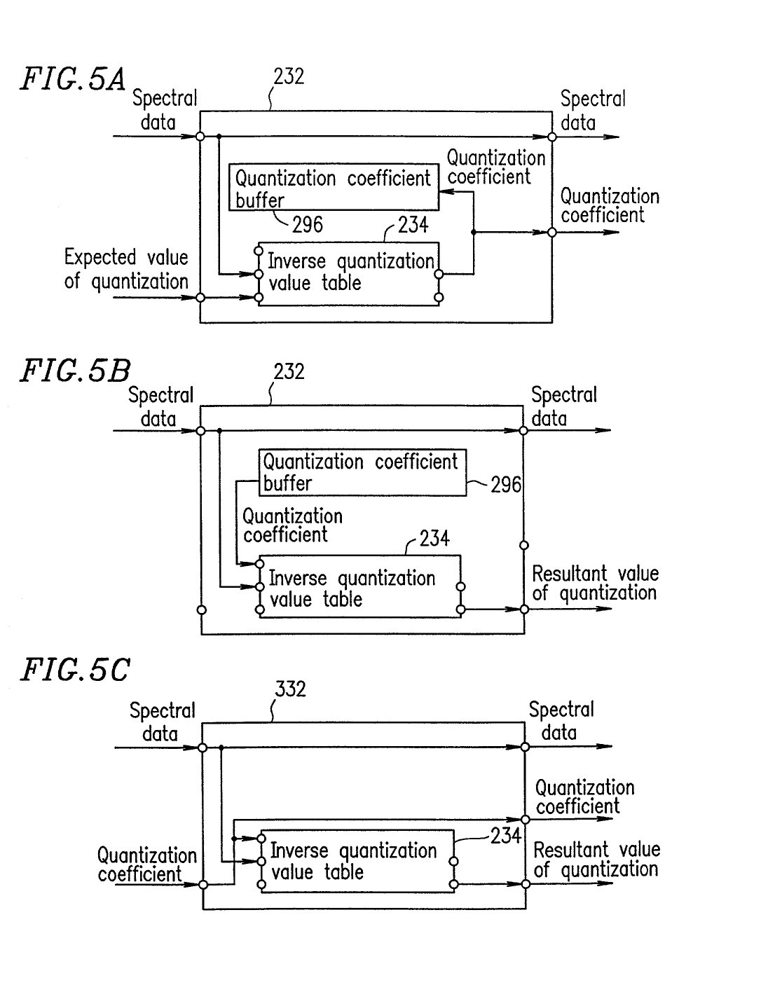

The quantization portion 232 determines a quantization coefficient for each sub-band using the expected value of quantization determined by the expected-value-of-quantization adjustment portion 231 and the inverse quantization value table 234 in the quantization portion 232. Further, the quantization portion 232 quantizes all of the spectral data contained in each sub-band using the quantization coefficient and the inverse quantization value table 234 to obtain the resultant value of quantization. The details of the operation of the quantization portion 232 will be described later with reference to FIGS. 5A and 5B, and 6 through 8.

The determination portion 233 calculates quantization cost and quantization noise based on the quantization coefficient and a resultant value of quantization obtained by the quantization portion 232. The quantization cost is represented by the number of bits required for transmission or accumulation of a resultant value of quantization. When both the quantization cost and the quantization noise are smaller than or equal to corresponding allowable values, the quantization coefficient and the resultant value of quantization are output to the output portion 140 (FIG. 1). When either the quantization cost or the quantization noise exceeds the corresponding allowable value, the result of the determination indicating that situation is output to the expected-value-of-quantization adjustment portion 231. The expected-value-of-quantization adjustment portion 231 adjusts the expected value of quantization depending on the result of the determination received from the determination portion 233. This determination is conducted in a similar way as to when the expected-value-of-quantization adjustment portion 132 (FIG. 2) adjusts the expected value of quantization depending on the result of the determination received from the determination portion 138. For example, the expected-value-of-quantization adjustment portion 231 adjusts the expected value of quantization so that the expected value of quantization is increased by one for a sub-band having quantization noise larger than a predetermined value. When the expected value of quantization is increased for a sub-band having a large amount of quantization noise, audio quality is efficiently improved.

FIGS. 5A and 5B show a data flow in the quantization device 232.

FIG. 5A shows that a quantization coefficient is obtained based on the inverse quantization value table 234 using spectral data input to the quantization portion 232 and the expected value of quantization. The obtained quantization coefficient is output to the quantization portion 232, and is stored in a quantization coefficient buffer 296 as a quantization coefficient for a specific sub-band. The quantization coefficient is obtained so that a resultant value of quantization obtained by quantizing one selected spectral data contained in a specific sub-band is substantially equal to the expected value of quantization. Such an operation of the quantization portion 232 is called a “quantization coefficient determination operation”. The quantization coefficient determination operation is executed for one spectral data selected from a plurality of spectral data contained in a specific sub-band.

FIG. 5B shows that a quantization coefficient is obtained based on the inverse quantization value table 234 using spectral data input to the quantization portion 232 and the expected value of quantization stored in the quantization coefficient buffer 296. The obtained resultant value of quantization is output to the quantization portion 232. The resultant value of quantization is obtained by quantizing spectral data. Such an operation of the quantization portion 232 is called a “quantization operation”. The quantization operation is executed for all of the spectral data contained in a specific sub-band.

The inverse quantization value table 234 regulates a relationship among a quantization coefficient, a resultant value of quantization, and an inverse quantization value. The relationship among a quantization coefficient (SCALEFACTOR) and a resultant value of quantization (xQuant) and the inverse quantization value (inv_mdct_line) is represented by the following formula:

$${inv}_{—} {mdct}_{—} line = sign ( xQuant ) \times {( xQuant )}^{\frac{4}{3}} \times {2}^{\frac{SCALEFACTOR}{4}} . \qquad ( 4 )$$

The relationship shown in FIG. 4 is equivalent to an inverse quantization formula described in the AAC specification.

The inverse quantization value table 234 may include a first inverse quantization value table defining a relationship between a quantization coefficient and an inverse quantization value for a predetermined resultant value of quantization, and a second inverse quantization value table defining a relationship between a resultant value of quantization and an inverse quantization value for a predetermined quantization coefficient.

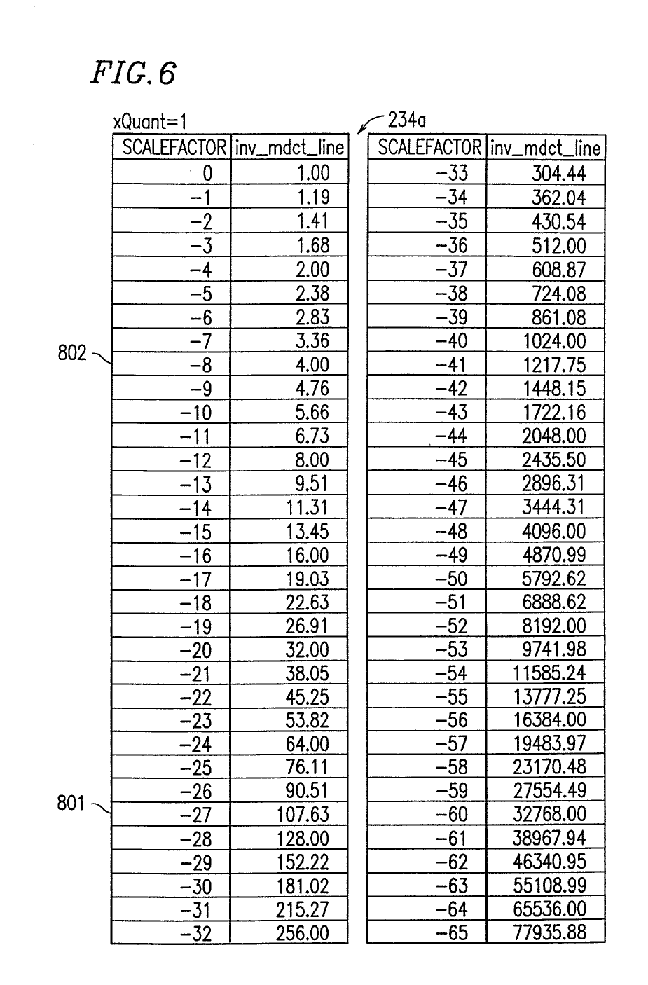

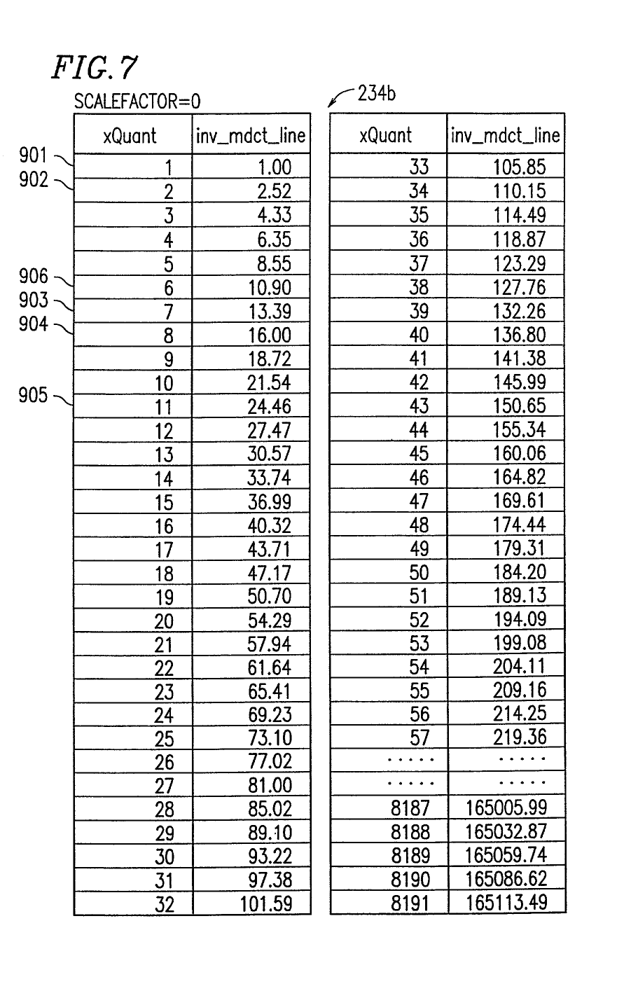

FIGS. 6 and 7 respectively show an example of the first and second inverse quantization value tables included in the inverse quantization value table 234.

The first inverse quantization value table 234a of FIG. 6 defines a relationship between a quantization coefficient (SCALEFACTOR) and an inverse quantization value (Inv_mdct line) when a resultant value of quantization (xQuant) is one. Since it is assumed that xQuant=1, formula (4) becomes the following formula:

$${inv}_{—} {mdct}_{—} line = {2}^{\frac{SCALEFACTOR}{4}} . \qquad ( 5 )$$

Note that a sign for indicating negativity or positivity is omitted in formula (5).

The first inverse quantization value table 234a of FIG. 6 shows inverse quantization values up to the second decimal place. The precision of the inverse quantization values may be changed depending on a hardware size such as the capacity of a memory for the first inverse quantization value table 234a.

Further, the table length of the first inverse quantization value table 234a is not limited to the length shown in FIG. 6 corresponding to the quantization coefficient range of −65 to 0. For example, the table length of the first inverse quantization value table 234a may be designed so that all of the possible quantization coefficients are listed, or may be equal to “1”, i.e., only one quantization coefficient is listed. When the table length of the first inverse quantization value table 234a is “1”, the first inverse quantization value table 234a defines an inverse quantization value for a quantization coefficient which is used as a reference. Even in this case, an inverse quantization value can be obtained for a quantization coefficient other than the reference quantization coefficient. This is because as is determined from formula (5), there is a relationship between a quantization coefficient and an inverse quantization value, in which, when the quantization coefficient is decreased by “n”, the inverse quantization value is increased by a factor of about 1.19ⁿ(=2^{(n/4)}). According to this relationship, an inverse quantization value can be obtained for a quantization coefficient which is not listed in the first inverse quantization value table 234a.

Further, as is determined formula (5), when a quantization coefficient is decreased by “4”, an inverse quantization value increases by a factor of 2. Therefore, when the table length of the first inverse quantization value table 234a is set to “4”, the following advantage is preferably obtained for calculation.

For example, when the first inverse quantization value table 234a defines inverse quantization values {1.00, 1.19, 1.41, 1.68} corresponding to the four quantization coefficients {0, −1, −2, −3}, inverse quantization values corresponding to four quantization coefficients {−4, −5, −6, −7} which are smaller by “4” than the quantization coefficients listed in the first inverse quantization value table 234a are calculated as {2.00, 2.38, 2.82, 3.36}. These values are easily obtained by doubling the inverse quantization values listed in the first inverse quantization value table 234a. There is a relationship in which when a quantization coefficient is increased by “4”, an inverse quantization value is multiplied by a factor of 1/2. The multiplication by a factor of 2 or 1/2 can be easily realized by a bit-shift operation in hardware, resulting in low calculation cost.

According to the above-described principle, the table length of the first inverse quantization value table 234a can be arbitrarily designed.

The second inverse quantization value table 234b of FIG. 7 defines a relationship between a resultant value of quantization (xQuant) and an inverse quantization value (inv_mdct_line) when a quantization coefficient (SCALEFACTOR) is zero. Since it is assumed that SCALEFACTOR=0, formula (4) becomes the following formula:

$${inv}_{—} {mdct}_{—} line = {( xQuant )}^{\frac{4}{3}} . \qquad ( 6 )$$

Note that a sign for indicating negativity or positivity is omitted in formula (6).

The second inverse quantization value table 234b of FIG. 7 shows inverse quantization values up to the second decimal place. The precision of the inverse quantization values may be changed depending on a hardware size, such as the capacity of a memory for the second inverse quantization value table 234b.

Further, the table length of the second inverse quantization value table 234b is not limited to the length shown in FIG. 7 corresponding to a range of 1 to 8191 of a resultant value of quantization. In AAC, although the possible range of resultant values of quantization ranges from 0 to 8191, all of the range is not necessarily listed in the second inverse quantization value table 234b. An inverse quantization value can be easily obtained for a resultant value of quantization which is not listed in the second inverse quantization value table 234b, using formula (6), according to a principle similar to the principle according to which the table length of the first inverse quantization value table 234a can be shortened as described with reference to FIG. 6. The table length of the second inverse quantization value table 234b can be set to an arbitrary value.

Hereinafter, a “quantization coefficient determination operation” and a “quantization operation” based on the second inverse quantization value table 234 will be described.

Initially, a quantization coefficient determination operation will be described with reference to FIG. 5A. The term “quantization coefficient determination operation” means an operation of the quantization portion 232 for determining a quantization coefficient for a specific sub-band.

Each band contains a plurality of spectral data. A quantization coefficient is determined for one spectral data selected from the plurality of quantization coefficients. It is now assumed that the selected one spectral data is the largest spectral data of the plurality of spectral data contained in the specific sub-band.

For example, the specific sub-band contains four spectral data {50.00, 60.00, 100.00, 40.00}, and an expected value of quantization is determined by the expected-value-of-quantization adjustment portion 231 (FIG. 4)so as to be “1”. In this case, the selected one spectral data (mdct_line) is “100.00”. By looking up the first inverse quantization value table 234a of FIG. 6 to find an inverse quantization value (inv_mdct_line) closest to “100.00”, inv_mdct_line=107.63 is found (at row 801). The corresponding SCALEFACTOR is −27. The first inverse quantization value table 234a of FIG. 6 shows a relationship between a quantization coefficient and an inverse quantization value when a resultant value of quantization is “1”. According to the table, an inverse quantization value obtained by inversely quantizing the resultant value of quantization of “1” using a quantization coefficient “−27”, is “107.63”. The expected value of quantization of “1” is equal to the resultant value of quantization of “1”. Therefore, the inverse quantization value obtained by inversely quantizing the expected value of quantization “1” using a quantization coefficient “−27”, is “107.63”. The inverse quantization value is substantially equal to the selected one spectral data

Since inverse quantization values listed in the first inverse quantization value table 234a are discrete, an inverse quantization value equal to one selected spectral data is not necessarily listed in the first inverse quantization value table 234a. Therefore, an attempt is made to find an inverse quantization value closest to the selected one spectral data among those listed in the first inverse quantization value table 234a.

In the above-described example, when a first inverse quantization value table is searched for an inverse quantization value, an inverse quantization value closest to the selected one spectral data is a target for the search.

Alternatively, a target for the search may be an inverse quantization value closest to but not smaller than the selected one spectral data among those listed in a first inverse quantization value table. In this case, an inverse quantization value obtained by inversely quantizing an expected value of quantization using a quantization coefficient determined by the quantization portion 232, can be kept from being smaller than the selected one spectral data. A target for the search may be an inverse quantization value closest to but not greater than the selected one spectral data. In this case, an inverse quantization value obtained by inversely quantizing an expected value of quantization using a quantization coefficient determined by the quantization portion 232, can be kept from being greater than the selected one spectral data.

Either of an inverse quantization value closest to but not smaller than the selected one spectral data or an inverse quantization value closest to but not greater than the selected one spectral data may be sought based on predetermined weight coefficients. For example, an inverse quantization value which results in |(the selected one spectral data−the inverse quantization value)×the predetermined weight coefficient| being the smallest, may be a target for the search. The predetermined weight coefficient may be different between when the selected one spectral data>an inverse quantization value and when the selected one spectral data≦the inverse quantization value. A quantization coefficient determined by the quantization portion 232 when an inverse quantization value closest to but not greater than the selected one spectral data is a target for the search is defined as a first quantization coefficient. A quantization coefficient determined by the quantization portion 232 when an inverse quantization value closest to but not smaller than the selected one spectral data is a target for the search is defined as a second quantization coefficient. In this case, an inverse quantization value obtained by inversely quantizing an expected value of quantization using the first quantization coefficient is not greater than the selected one spectral data. An inverse quantization value obtained by inversely quantizing an expected value of quantization using the second quantization coefficient is not smaller than the selected one spectral data. To seek either of an inverse quantization value closest to but not smaller than the selected one spectral data or an inverse quantization value closest to but not greater than spectral data based on the predetermined weight coefficient means that either of the first and second quantization coefficients is selected as a quantization coefficient for a specific sub-band based on a predetermined condition.

Audio quality is varied depending on whether an inverse quantization value obtained by inversely quantizing an expected value of quantization using a quantization coefficient determined by the quantization portion 232 is not greater than or not smaller than the selected one spectral data. Therefore, it is possible to easily adjust the audio quality by selecting a method for searching a first inverse quantization value table for an inverse quantization value.

An inverse quantization value found in such a search can be said to be “substantially equal to” spectral data.

Next, a quantization coefficient determination operation when an expected value of quantization for a certain sub-band is not “1”, will be described.

For example, when an expected value of quantization is “2”, the first inverse quantization value table 234a is modified so as to define a relationship between a quantization coefficient and an inverse quantization value when a resultant value of quantization (xQuant) is equal to the expected value of quantization. That is, the first inverse quantization value table 234a is modified so as to define a relationship between a quantization coefficient and an inverse quantization value when a resultant value of quantization (xQuant) is equal to “2”. Such a modification is performed as follows.

Comparing rows 901 and 902 in the second inverse quantization value table 234b of FIG. 7, an inverse quantization value (inv_mdct_line) when a resultant value of quantization (xQuant) is equal to “2” is 2.52 times an inverse quantization value when a resultant value of quantization is equal to “1”. Such a factor is not dependent on a quantization coefficient (SCALEFACTOR). Therefore, all of the inverse quantization values (inv_mdct_line) listed in the first inverse quantization value table 234a are multiplied by 2.52, thereby modifying the first inverse quantization value table 234a so as to define a relationship between a quantization coefficient and an inverse quantization value when a resultant value of quantization (xQuant) is “2”. With the modified first quantization value table, a quantization coefficient when an expected value of quantization is “2” is determined in accordance with a procedure similar to that for the above-described quantization coefficient determination operation when an expected value of quantization is “1”.

As described below, a rate of change of an inverse quantization value when a resultant value of quantization is modified is not dependent on a quantization coefficient.

An inverse quantization value inv_mdct_dct_line1 when a resultant value of quantization is xQuant1, is given by:

$${inv}_{—} {mdct}_{—} line1 = {( xQuant1 )}^{\frac{4}{3}} \times {2}^{\frac{SCALEFACTOR}{4}} . \qquad ( 7 )$$

Note that a sign for indicating negativity or positivity is omitted in formula (7).

An inverse quantization value inv_mdct_line2 when a resultant value of quantization is xQuant2, is given by:

$${inv}_{—} {mdct}_{—} line2 = {( xQuant2 )}^{\frac{4}{3}} \times {2}^{\frac{SCALEFACTOR}{4}} . \qquad ( 8 )$$

Note that a sign for indicating negativity or positivity is omitted in formula (8).

A ratio of the two inverse quantization values inv_mdct_line2 and inv_mdct_line1 is given by:

$$\frac{{inv}_{—} {mdct}_{—} line2}{{inv}_{—} {mdct}_{—} line1} = {( \frac{xQuant2}{xQuant1} )}^{\frac{4}{3}} . \qquad ( 9 )$$

According to formula (9), the ratio of the two inverse quantization values inv_mdct_line2 and inv_mdct_line1 is independent of a quantization coefficient SCALEFACTOR.

Instead of modifying the first inverse quantization value table 234a so as to multiply all of the inverse quantization values (inv_mdct_line) listed in the table by 2.52 as described above, an alternative method may be used as follows. The first inverse quantization value table 234a is not modified and an inverse quantization value which is substantially equal to a value obtained by dividing one selected spectral data (mdct_line) by 2.52 is sought so as to obtain a quantization coefficient (SCALEFACTOR). Dividing by 2.52 is equivalent to multiplying by an inverse of 2.52. Therefore, an inverse quantization value defined by a second inverse quantization value table may be listed as an inverse in advance.

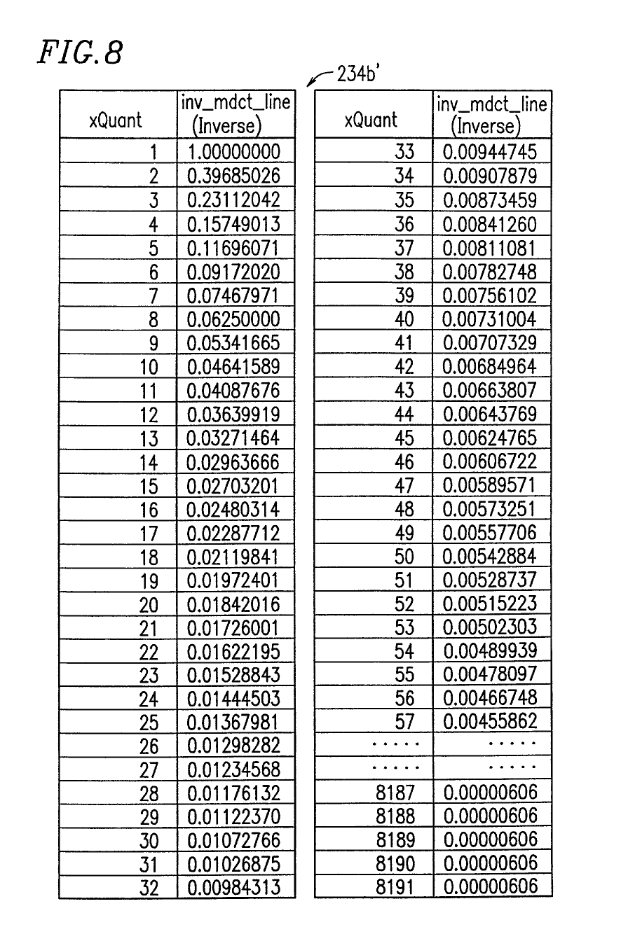

FIG. 8 shows an exemplary second inverse quantization value table 234b′ listing an inverse quantization value as an inverse. Particularly for hardware including a multiplier, multiplication is more preferable than division in terms of low calculation cost. Therefore, it is preferable that the second inverse quantization value table 234b′ of FIG. 8 is used instead of the second inverse quantization value table 234b of FIG. 7. The second inverse quantization value table 234b′ of FIG. 8 shows inverses of inverse quantization values up to the eighth decimal place. The precision of the inverse quantization values may be changed depending on a hardware size and the like.

Alternatively, instead of modifying the first inverse quantization value table 234a in response to a change in a resultant value of quantization (xQuant) as described above, the first inverse quantization value table 234a may define a relationship between a quantization coefficient and an inverse quantization value for all possible resultant values of quantization.

An inverse quantization value obtained by inversely quantizing an expected value of quantization for a certain sub-band using a quantization coefficient determined as described above, is substantially equal to one spectral data selected from a plurality of spectral data contained in the sub-band. Quantization and inverse quantization are in a relationship of inverse transformation when the same quantification coefficient is used in both cases. A resultant value of quantization obtained by quantizing one selected spectral data using such a quantization coefficient is substantially equal to an expected value of quantization. Therefore, it is possible to suppress an unexpectedly low resultant value of quantization which leads to deterioration in audio quality.

Next, an quantization operation by the quantization portion 232 of FIG. 5B will be described. The term “quantization operation” means an operation of the quantization portion 232 quantizing spectral data contained in a specific sub-band using a quantization coefficient, i.e., an operation of determining a resultant value of quantization.

Upon a quantization operation in the quantization portion 232, a quantization coefficient is already determined for each sub-band, which is stored in the quantization coefficient buffer 296.

For example, a quantization coefficient is “−8” for a certain sub-band, and the specific sub-band contains spectral data {50.00, 60.00, 100.00, 40.00}. Quantization of these spectral data is performed as follows.

(a) the first inverse quantization value table 234a (FIG. 6) is searched for a quantization coefficient for a current sub-band to obtain an inverse quantization value. In this case, a quantization coefficient (SCALEFACTOR) “−8” is sought to obtain an inverse quantization value (inv_mdct_line) “4.00” (the row 802).

(b) spectral data contained in the current sub-band is divided by the inverse quantization value (inv_mdct_line) obtained in (a). In this case, the results of the division are obtained {12.50, 15.00, 25.00, 10.00}.

(c) the second inverse quantization value table 234b (FIG. 7) is searched for an inverse quantization value closest to each of the results of the division obtained in (b) to obtain a resultant value of quantization. In this case, the resultant values of the quantization of {7, 8, 11, 6} corresponding to respective spectral data contained in the sub-band are obtained (the rows 903, 904, 905, and 906). These are the result values of the quantization of the current (specific) sub-band. When the thus-determined resultant value of quantization are inversely quantized using the quantization coefficient already determined for the current sub-band, the resultant inverse quantization values are substantially equal to respective spectral data contained in the sub-band.

In an example shown in (c), an inverse quantization value closest to a result of division is sought when a second inverse quantization value table is searched for an inverse quantization value. Alternatively, a target for the search may be an inverse quantization value closest to but not smaller than a result of division. In this case, an inverse quantization value obtained by inversely quantizing each resultant value of quantization using a quantization coefficient already determined by the quantization portion 232 for a specific sub-band, can be kept from being smaller than respective spectral data contained in the specific sub-band.

Alternatively, a target for the search may be an inverse quantization value closest to but not greater than a result of division. In this case, an inverse quantization value obtained by inversely quantizing each resultant value of quantization using a quantization coefficient already determined by the quantization portion 232 for a specific sub-band, can be kept from being greater than respective spectral data contained in the specific sub-band.

Alternatively, for one specific spectral data of a plurality of spectral data contained in a specific sub-band, either of an inverse quantization value closest to but not smaller than a result of division or an inverse quantization value closest to but not greater than a result of division may be sought based on predetermined weight coefficients. For example, the smallest inverse quantization value which results in |(a result of division −the inverse quantization value)×a predetermined weight coefficient| being the smallest, may be a target for the search. The predetermined weight coefficient may be different between when the result of division>an inverse quantization value and when the result of division≦an inverse quantization value. A resultant value of quantization determined by the quantization portion 232 when an inverse quantization value closest to but not greater than the result of division is a target for the search is defined as a first resultant value of quantization. A resultant value of quantization determined by the quantization portion 232 when an inverse quantization value closest to but not smaller than the result of division is a target for the search is defined as a second resultant value of quantization. In this case, an inverse quantization value obtained by inversely quantizing the first resultant value of quantization using a quantization coefficient already determined is not greater than the specific spectral data. An inverse quantization value obtained by inversely quantizing the second resultant value of quantization using the quantization coefficient coefficient already determined is not smaller than the specific spectral data. To seek either of an inverse quantization value closest to but not smaller than the result of division or an inverse quantization value closest to but not greater than the result of division based on the predetermined weight coefficient means that either of the first and second resultant values of quantization is selected as a resultant value of quantization for one specific spectral data of a plurality of spectral data in a specific sub-band based on a predetermined condition.

Audio quality is varied depending on whether an inverse quantization value obtained by inversely quantizing a resultant value of quantization determined by the quantization portion 232 for each of a plurality of spectral data contained in a specific sub-band, using a quantization coefficient already determined, is not greater than or not smaller than spectral data. Therefore, it is possible to easily adjust the audio quality by changing a method for searching a second inverse quantization value table for an inverse quantization value.

Alternatively, instead of dividing spectral data by an inverse quantization value (inv_mdct_line) (“4.00” in the above-described example) obtained by searching the first inverse quantization value table 234a, all of the inverse quantization values listed in the second inverse quantization value table 234b are multiplied by that inverse quantization value to modify the second inverse quantization value table 234b. The modified second inverse quantization value table 234b defines a relationship between a resultant value of quantization and a resultant value of inverse quantization for a quantization coefficient for a current sub-band.

Instead of the division in (b), an inverse may be multiplied. In this case, an inverse quantization value listed in the first inverse quantization value table 234a may be represented as an inverse. Particularly for hardware including a multiplier, multiplication is more preferable than division in terms of low calculation cost, so that it is preferable that an inverse quantization value is represented by an inverse of that value.

The quantization coefficient determination operation and the quantization operation of the quantization portion 232 are thus described. As described above, a quantization coefficient for a specific sub-band is determiend (quantization coefficient determination operation), and each of a plurality of spectral data contained in the specific sub-band is quantized using the quantization coefficient for the specific sub-band (quantization operation). As described above, the quantization portion of Example 2 determines a quantization coefficient so that an inverse quantization value obtained by inversely quantizing an expected value of quantization already determined, using the quantization coefficient, is substantially equal to one spectral data selected from a plurality of spectral data contained in the sub-band. A resultant value of quantization obtained by quantizing the one selected spectral data using the quantization coefficient, is substantially equal to an expected value of quantization. Therefore, it is possible to suppress an unexpectedly low resultant value of quantization which leads to deterioration in audio quality. Such an operation is performed for all sub-bands, and therefore deterioration in audio quality is suppressed for all sub-bands. Thus, a solution is given to the problem of the conventional technique, in which only a quantization coefficient is adjusted, resulting in an unexpectedly low resultant value of quantization which leads to deterioration in audio quality. Particularly when the number of bits which can be allocated for an encoded bit stream is limited, i.e., at a low bit rate, it is important to secure a minimum level of audio quality. According to Example 2, the minimum level of audio quality can be secured by setting an expected value of quantization in advance, which is particularly effective in the case of a low bit rate. Both the quantization coefficient determination operation and the quantization operation in the quantization portion 232 do not include exponentiation operation, resulting in low calculation cost.

Note that in Example 2, when it is sufficient that the minimum level of audio quality is secured, the determination portion can be omitted.

### EXAMPLE 3

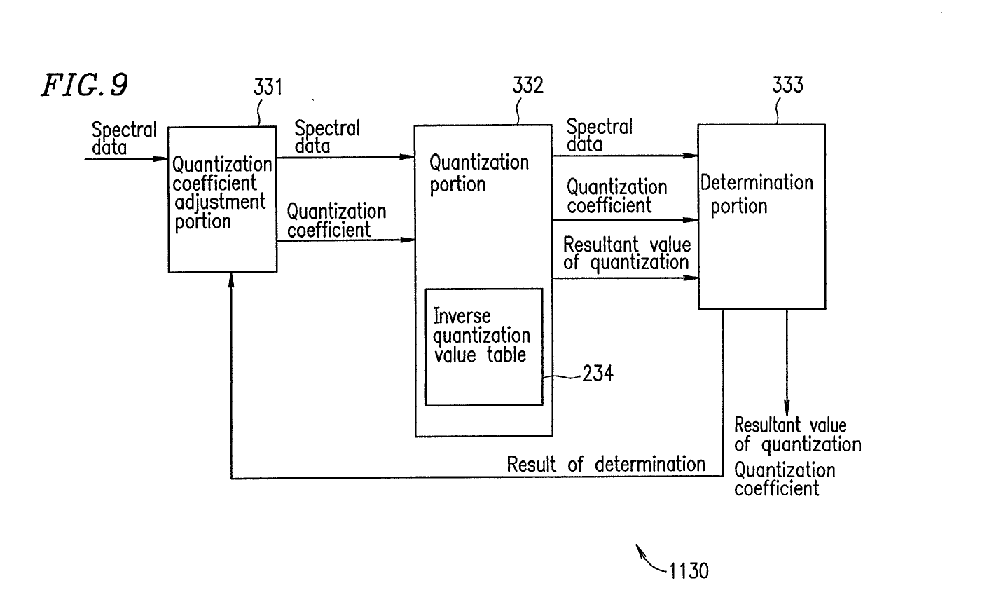

FIG. 9 shows a configuration of a quantization device 1130 according to Example 3 of the present invention. The quantization device 1130 is used instead of the quantization device 130 in the encoder 100 of FIG. 1.

The quantization device 1130 comprises: a quantization coefficient adjustment portion 331 for determining a quantization coefficient; a quantization portion 332 for quantizing spectral data; and a determination portion 333 for judging quantization cost and quantization noise. The quantization portion 332 has an inverse quantization value table 234.

The quantization coefficient adjustment portion 331 receives spectral data on the frequency axis output from the conversion device 120 (FIG. 1), and determines a quantization coefficient for each sub-band. The quantization coefficient for each sub-band may be determined depending on spectral data contained in each sub-band, or alternatively, may be determined irrespective of spectral data.

The quantization portion 332 quantizes all of the spectral data contained in each sub-band using the quantization coefficient determined by the quantization coefficient adjustment portion 331 and the inverse quantization value table 234 in the quantization portion 332, to obtain a resultant value of quantization. The operation of the quantization portion 332 will be described later with reference to FIG. 5C.

The determination portion 333 calculates quantization cost and quantization noise based on the quantization coefficient and a resultant value of quantization obtained by the quantization portion 332. The quantization cost is represented by the number of bits required for transmission or accumulation of a resultant value of quantization. When both the quantization cost and the quantization noise are smaller than or equal to corresponding allowable values, the quantization coefficient and the resultant value of quantization are output to the output portion 140 (FIG. 1). When either the quantization cost or the quantization noise exceeds the corresponding allowable value, the result of the determination indicating that situation is output to the quantization coefficient adjustment portion 331. The quantization coefficient adjustment portion 331 receives the result of the determination, and then adjusts the quantization coefficient again.

FIG. 5C shows a data flow in the quantization device 332. The quantization portion 332 has an inverse quantization value table 234. The inverse quantization value table 234 is already described in Example 2. The operation of the quantization portion 332 is similar to the quantization operation of the quantization portion 232 described with reference to FIG. 5B. Note that a quantization coefficient is externally input to the quantization portion 332.

As described above in (c) of the procedure of the quantization operation in Example 2, audio quality is varied depending on whether an inverse quantization value obtained by inversely quantizing a resultant value of quantization for a specific sub-band determined by the quantization portion 332, using a quantization coefficient for the sub-band, is not greater than or not smaller than spectral data contained in the sub-band. Therefore, audio quality can be easily adjusted by changing a method for searching a second inverse quantization value table for an inverse quantization value in the quantization portion 332.

Further, the quantization operation of the quantization portion 332 does not use a quantization formula (formula (1) or (2)) required for exponentiation calculation, thereby making it possible to obtain a high-speed quantization operation.

### EXAMPLE 4

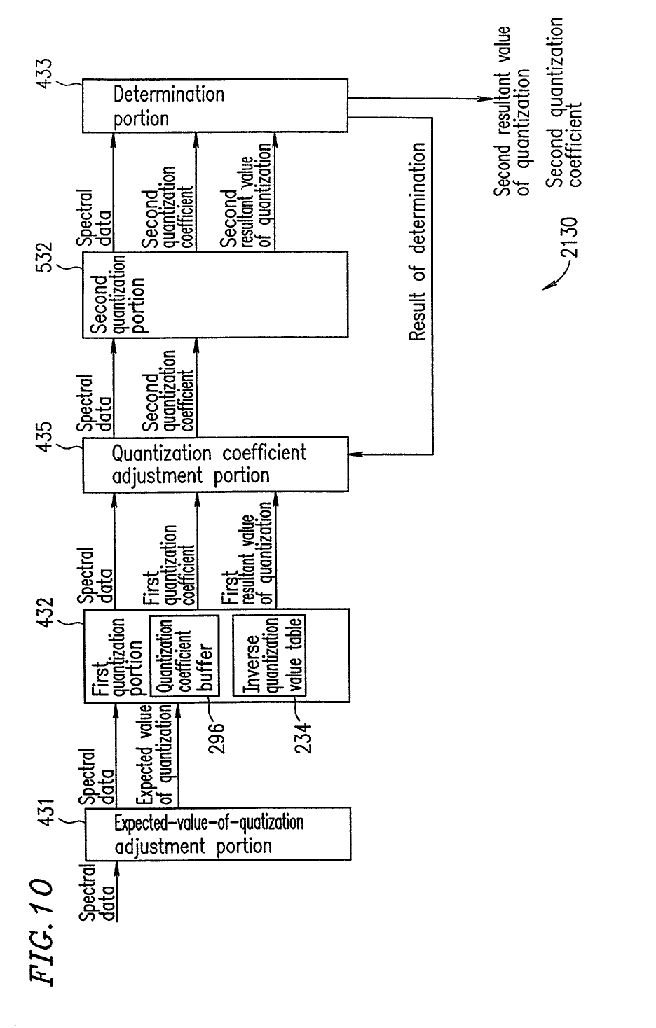

FIG. 10 shows a configuration of a quantization device 2130 according to Example 4 of the present invention. The quantization device 2130 is used instead of the quantization device 130 in the encoder 100 of FIG. 1.

The quantization device 2130 comprises: an expected-value-of-quantization adjustment portion 431 for determining an expected value of quantization; a first quantization portion 432 for determining an initial value of a quantization coefficient; a quantization coefficient adjustment portion 435 for determining a quantization coefficient; a second quantization portion 532 for quantizing spectral data; and a determination portion 433 for judging quantization cost and quantization noise. The first quantization portion 432 has an inverse quantization value table 234 and a quantization coefficient buffer 296 therein.

The expected-value-of-quantization adjustment portion 431 determines an expected value of quantization in a manner similar to that of the expected-value-of-quantization adjustment portion 231 of FIG. 4.

The first quantization portion 432 is operated in a manner similar to that of the quantization portion 232 of FIG. 4. Specifically, the first quantization portion 432 determines a quantization coefficient for each band as a first quantization coefficient, using an expected value of quantization determined by the expected-value-of-quantization adjustment portion 431 and the inverse quantization value table 234 in the first quantization portion 432 (quantization coefficient determination operation). Further, the first quantization portion 432 quantizes all of the spectral data contained in each sub-band using the first quantization coefficient and the inverse quantization value table 234 to obtain a first resultant value of quantization (quantization operation).

The first quantization portion 432 determines the first quantization coefficient so that a resultant value of quantization obtained by quantizing one spectral data selected from a plurality of spectral data contained in a specific sub-band using the first quantization coefficient for the specific sub-band is substantially equal to an expected value of quantization for the specific sub-band.

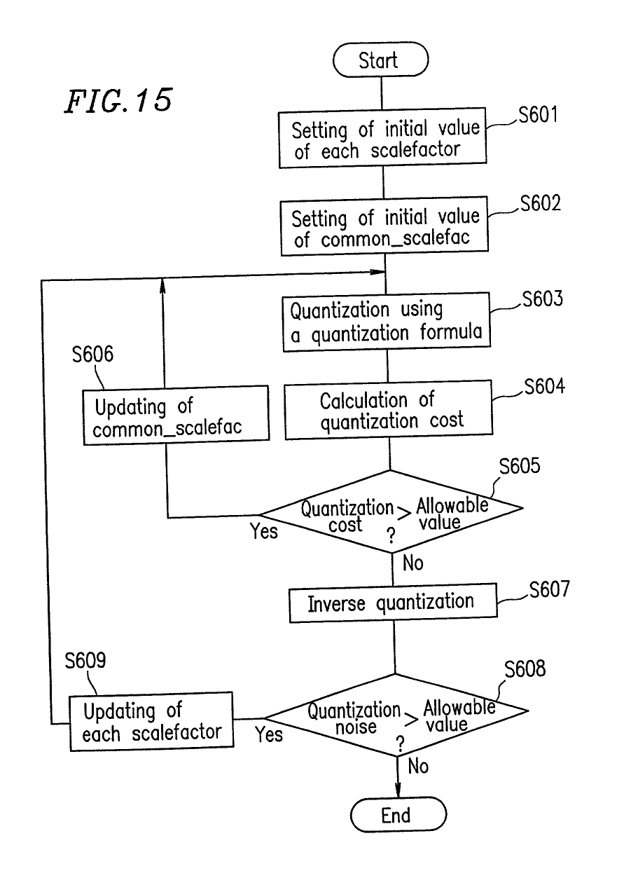

The quantization coefficient adjustment portion 435 receives the first quantization coefficient from the first quantization portion 432 as an initial value of a quantization coefficient, and adjusts the quantization coefficient. For example, the quantization coefficient adjustment portion 435, the second quantization portion 532, and the determination portion 433 calculate a quantization coefficient for a certain sub-band in accordance with a conventional procedure already described with reference to FIG. 15. The quantization coefficient adjustment portion 435 adopts the first quantization coefficient as a quantization coefficient when it is determined that the audio quality when the calculated quantization coefficient is used is poorer than the audio quality when the first quantization coefficient is used. Otherwise, a quantization coefficient calculated in accordance with the conventional procedure is adopted. The adopted quantization coefficient is output as a second quantization coefficient to the second quantization portion 136. Audio quality is represented by quantization noise, for example. The quantization noise can be calculated in a manner similar to that described in Example 1.

In other words, the quantization coefficient adjustment portion 435 adjusts a quantization coefficient so that quantization noise is not greater than quantization noise which may be obtained when each spectral data contained in a specific sub-band is quantized using the first quantization coefficient.

The second quantization portion 136 quantizes all of the spectral data contained in a certain sub-band based on the second quantization coefficient, and the result of the quantization is output as a second resultant value of quantization to the determination portion 433.

The operation of the determination portion 433 is similar to that of the determination portion 333 described with reference to FIG. 9.

For example, an expected value of quantization is set in the expected-value-of-quantization adjustment portion 431 in order to secure the minimum level of the audio quality. An expected value of quantization may be set to “1” for each sub-band, for example. When an expected value of quantization is set in this manner, the minimum level of audio quality (the quality of an encoded bit stream) is secured for the first quantization coefficient (an initial value of a quantization coefficient). When such a first quantization coefficient is used, deterioration in audio quality, which would be caused in a conventional technology, can be suppressed in AAC. Particularly when the number of bits which can be allocated for an encoded bit stream is limited to a value corresponding to the minimum level of the audio quality, the method of Example 4 is considerably effective.

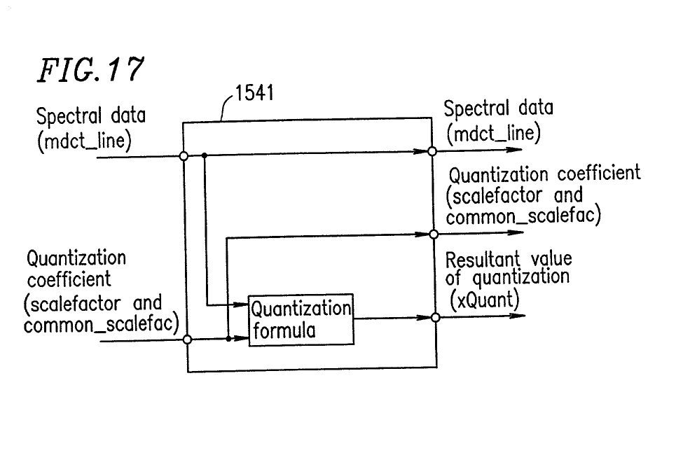

In Example 4, a conventional quantization portion 1541 shown in FIG. 17 may be used as the second quantization portion 532. Alternatively, the quantization portion 332 of Example 3 may be used. The quantization portion 2032 of FIG. 2 may be used as the first quantization portion 432.

When the quantization portion 332 of Example 3 shown in FIG. 5C is used as the second quantization portion 532, audio quality is dependent on whether an inverse quantization value obtained by inversely quantizing a resultant value of quantization determined by the quantization portion 332 for a specific sub-band using a quantization coefficient for the sub-band is not greater than or not smaller than spectral data contained in the sub-band. Therefore, audio quality can be easily adjusted by changing a method for searching the second inverse quantization value table for an inverse quantization value by the quantization portion 332.

In the above-described Examples 2 through 4, the inverse quantization value table 234 includes the first and second inverse quantization value tables. Alternatively, one or both of the first and second inverse quantization value tables may be represented by a relationship among a quantization coefficient, a resultant value of quantization, and an inverse quantization value, instead of the tables.

Further, in the first inverse quantization value table 234a of FIG. 6, a resultant value of quantization (xQuant) is fixed to “1”. However, a fixed resultant value of quantization (xQuant) is not limited to “1”. Similarly, a quantization coefficient (SCALEFACTOR) fixed in the second inverse quantization value table 234b of FIG. 7 is not limited to “0”.

### EXAMPLE 5

Hereinafter, a quantization device 1230 according to Example 5 of the present invention will be described.

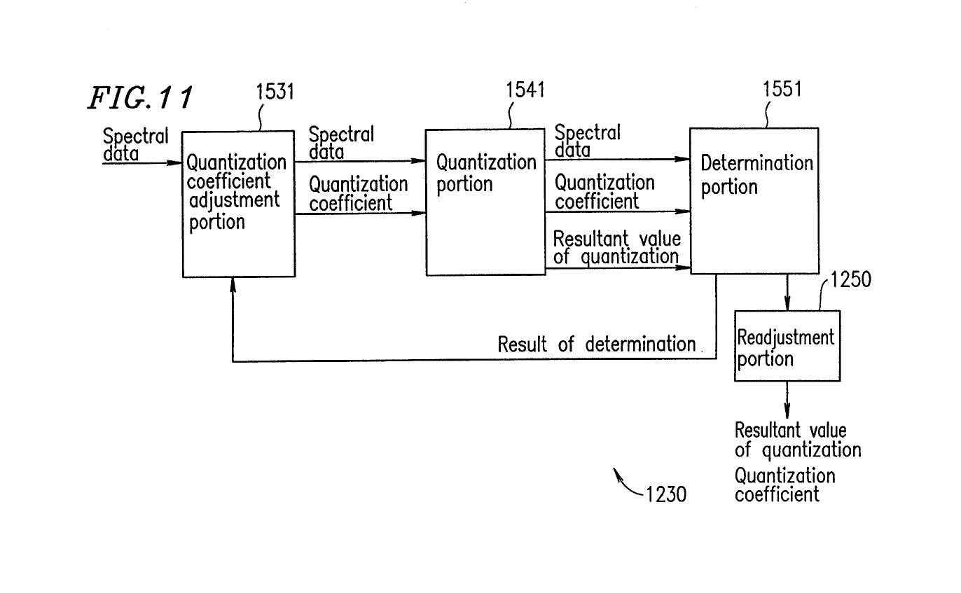

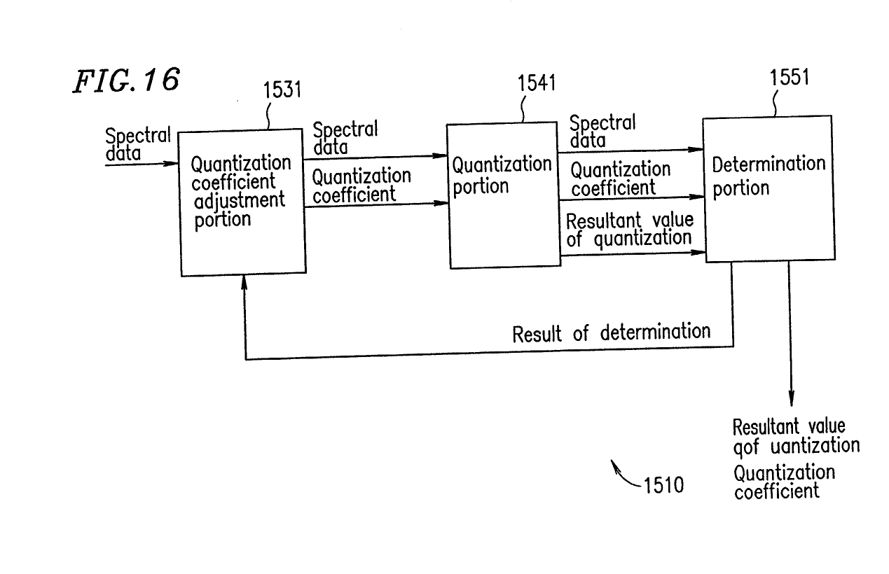

FIG. 11 shows a configuration of the quantization device 1230. In FIG. 11, the same components as those shown in FIG. 16 are referred to by the same reference numerals, and description thereof is thus omitted. The quantization device 1230 is used in the encoder 100 instead of the quantization device 130.

The quantization device 1230 includes a readjustment portion 1250 in addition of the components of the quantization device 1510 of FIG. 16.

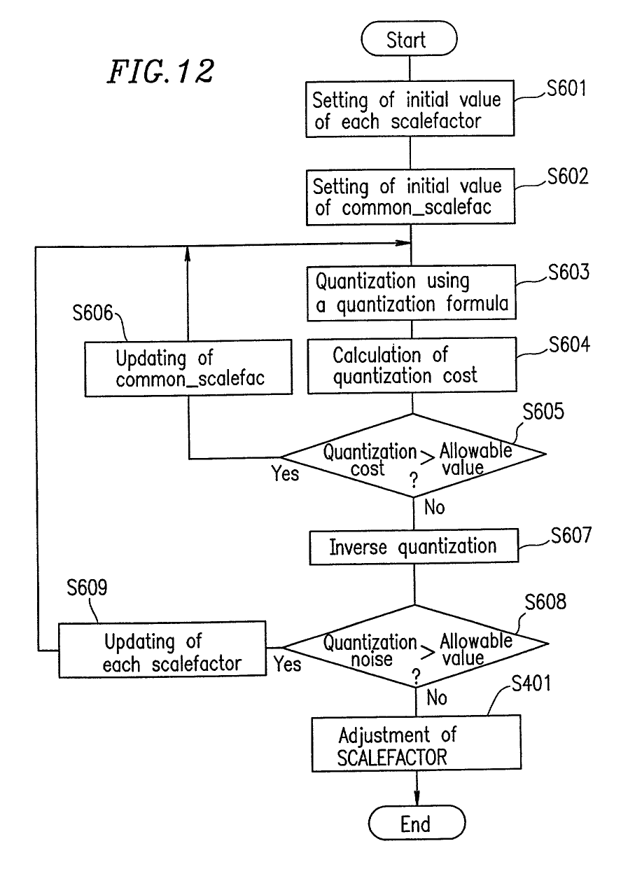

FIG. 12 shows a quantization procedure executed by the quantization device 1230. The same steps as those shown in FIG. 15 are referred to by the same reference numerals, and description thereof is thus omitted.

The quantization procedure of FIG. 12 has an additional step S401 to those of FIG. 15 after step S608 in the case of “NO”. In step S401, the value of a quantization coefficient (SCALEFACTOR) is adjusted. The adjustment of a quantization coefficient is executed by the readjustment portion 1250 of FIG. 11. Note that step S401 is not limited to the process shown in FIG. 15. Step S401 may be executed after an arbitrary quantization for determining a resultant value of quantization (xQaunt) and a quantization coefficient (SCALEFACTOR). Therefore, the readjustment portion 1250 of FIG. 11 may be provided at a subsequent stage of a component which executes an arbitrary quantization for determining a resultant value of quantization (xQaunt) and a quantization coefficient (SCALEFACTOR).

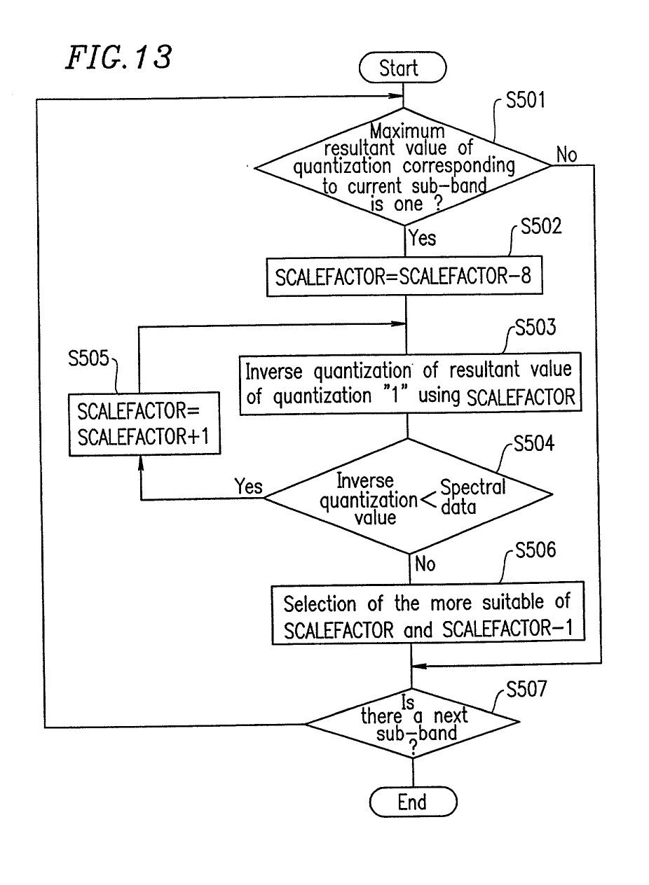

FIG. 13 shows a procedure for adjusting a quantization coefficient (SCALEFACTOR) (step S401 of FIG. 12). Hereinafter, each step shown in FIG. 13 will be described.

Step S501: it is determined whether the maximum value of a resultant value of quantization for a current sub-band is “1”. When the determination in step S501 is “Yes”, the process moves to step S502. When the determination in step S501 is “No”, the process ends for the current sub-band, and moves to a process for a next sub-band (step S507).

Step S502: the value of SCALEFACTOR is updated to the value of SCALEFACTOR minus 8. The value “8” is sufficient for an inverse quantization value obtained by inversely quantizing a resultant value of quantization using the updated value of SCALEFACTOR to be smaller than the original spectral data.

Step S503: a resultant value of quantization of “1” is inversely quantized using the updated value of SCALEFACTOR. As a result, an inverse quantization value is obtained.

Step S504: it is determined whether the inverse quantization value is smaller than the original spectral data. When the determination in step S504 is “Yes”, the process moves to step S505. When the determination in step S504 is “No”, the process moves to step S506. In other words, when the inverse quantization value becomes equal to or greater than the original spectral data, the process moves to step S506.

Step S505: the value of SCALEFACTOR is increased by one, and the process moves to step S503. Thus, steps S505 and S503 are repeated until the inverse quantization value is greater than or equal to the original spectral data.

Step S506: the value of SCALEFACTOR or the value of (SCALEFACTOR−1), which leads to small quantization noise, is selected.

An inverse quantization value is obtained by inversely quantizing the resultant value of quantization of “1” using the value of SCALEFACTOR. The absolute value of a difference between the inverse quantization value and the original data is represeted by D₀.

An inverse quantization value is obtained by inversely quantizing the resultant value of quantization of “1” using the value of (SCALEFACTOR−1). The absolute value of a difference between the inverse quantization value and the original data is represeted by D₁.

If D₀≦D₁, the value of SCALEFACTOR is output as a new value of SCALEFACTOR.

If D₀>D₁, the value of (SCALEFACTOR−1) is output as a new value of SCALEFACTOR.

Note that the value of SCALEFACTOR or the value of (SCALEFACTOR−1), which leads to an inverse quantization value which is greater and closer to than the original data, may be selected. Alternatively, one which leads to an inverse quantization value which is smaller than and closer to the original data, may be selected.

Alternatively, the value of SCALEFACTOR or the value of (SCALEFACTOR−1), which leads to the smaller sum of squares of a difference between each spectral data contained in a current sub-band and spectral data obtained inversely quantizing the resultant value of quantization of that spectral data, may be selected. Alternatively, one which leads to the smaller sum of the absolute value of the differences may be selected.

Step S507:the process for the current sub-band ends. Thereafter, the process for a next current sub-band starts.

In this manner, all sub-bands are subjected to a procedure similar to the above-described procedure.

As described above, according to Example 2, an optimal value of SCALEFACTOR can be selected without changing a resultant value of quantization. Therefore, high-quality encoding capable of producing spectral data closer to the original sound can be achieved.

Note that in the example shown in FIG. 13, the value of SCALEFACTOR is adjusted only when the maximum of the resultant value of quantization for a sub-band is one. The present invention is not limited to this. When the maximum value of the resultant value of quantization for a sub-band is a value other than one, a similar process can be executed.

### EXAMPLE 6

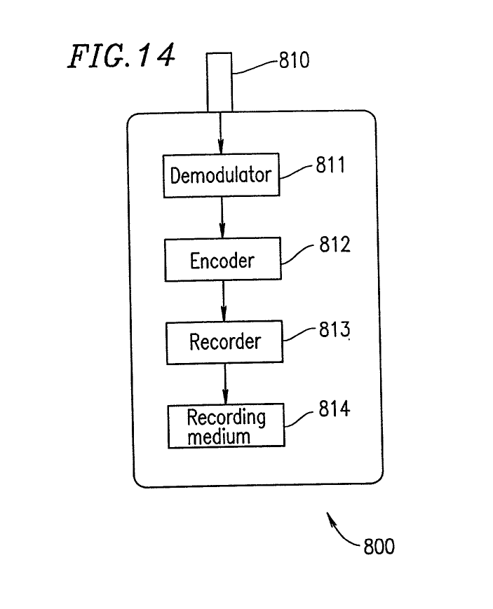

FIG. 14 shows a configuration of a communication device 800 including the encoder of the present invention. The communication device 800 includes an antenna 810, a demodulator 811, an encoder 812, and a recorder 813. The communication device 800 is a cellular phone, for example.

The demodulator 811 demodulates an input signal received through the antenna 810 to obtain digital audio data. The demodulator 811 may have any known structure for obtaining digital audio data by demodulating an input signal.

The encoder 812 encodes the digital audio data to obtain an encoded bit stream.

The recorder 813 records the encoded bit stream into a recording medium 814. Any recording medium, such as an SD card, may be used as the recording medium 814, for example.

Thus, the communication device 800 can record audio data contained in an input signal received through the antenna 810.

The encoder 100 (FIG. 1) of the present invention can be preferably used as the encoder 812. The encoder 100 of the present invention can transmit or accumulate audio data at a low bit rate while maintaining the high quality of the data. Therefore, long-time audio data can be recorded in a recording medium having a small capacity.

The encoding processes described in Examples 1 through 5 may be stored in a recording medium in the form of a program. As the recording medium, any computer-readable recording media, such as a floppy disk and a CD-ROM, may be used. In this case, if the encoding process program is read from the recording medium and then installed on a computer, the computer can function as an encoder.

According to the present invention, an expected value of quantization is initially given. One spectral data selected from a plurality of spectral data contained in a specific sub-band on the frequency axis is quantized to obtain a resultant value of quantization. A quantization coefficient is determined for the specific sub-band so that the resultant value of quantization becomes equal to the expected value of quantization. Similarly, a quantization coefficient is determined for each sub-band on the frequency axis. The resultant value of quantization is adjusted depending on the number of bits which can be allocated for an encoded bit stream.

When a quantization coefficient for a specific sub-band is determined in this manner, the resultant value of quantization of one spectral data selected from a plurality of spectral data contained in the specific sub-band cannot be smaller than the expected value of quantization. When it is secured that the resultant value of quantization of one spectral data selected from a plurality of spectral data contained in the specific sub-band cannot be smaller than the expected value of quantization, deterioration in data quality can be suppressed. Similarly, it is secured that the resultant value of quantization of one spectral data selected from a plurality of spectral data contained in each sub-band cannot be smaller than the expected value of quantization, resulting in suppression of deterioration in data quality.

Further, according to the present invention, when a resultant value of quantization is equal to the expected value of quantization for a plurality of quantization coefficients, one of the plurality of quantization coefficients, which leads to a minimum level of quantization noise, is selected, and the selected quantization coefficient is determined as a quantization coefficient of a specific sub-band.

Thus, when a quantization coefficient which leads to a minimum level of quantization noise is selected, deterioration in data quality is limited so as to be at a minimum.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An encoder comprising:
an input device for sampling an input signal at predetermined time intervals to obtain sampled data on a temporal axis;
a conversion device for converting the sampled data on the temporal axis to spectral data on a frequency axis:
a quantization device for quantizing the spectral data on the frequency axis; and
an output device for outputting a resultant value of quantization as an encoded bit stream,
wherein the quantization device comprises:
an expected-value-of-quantization adjustment portion for determining an expected value of quantization for a specific sub-band on the frequency axis; and
a quantization portion for determining a quantization coefficient for the specific sub-band, and quantizing each of a plurality of spectral data contained in the specific sub-band using the quantization coefficient for the specific sub-band, and
the quantization coefficient for the specific sub-band is determined so that a resultant value of quantization obtained by quantizing one spectral data selected from the plurality of spectral data contained in the specific sub-band, using the quantization coefficient for the specific sub-band, is substantially equal to the expected value of quantization for the specific sub-band.

2. An encoder according to claim 1,
wherein the quantization portion comprises:
a first quantization portion for obtaining a resultant value of quantization by quantizing the selected one spectral data;
a quantization coefficient determination portion for determining the quantization coefficient for the specific sub-band; and
a second quantization portion for quantizing each of the plurality of spectral data contained in the specific sub-band, using the quantization coefficient for the specific sub-band,
the quantization coefficient determination portion modifies an initial value of the quantization coefficient by a predetermined amount to obtain at least one quantization coefficient, and compares at least one resultant value of quantization obtained by the first quantization portion using the at least one quantization coefficient with the expected value of quantization for the specific sub-band, and determines a quantization coefficient so that a resultant value of quantization is substantially equal to the expected value of quantization, and
the expected-value-of-quantization adjustment portion adjusts the expected value of quantization for the specific sub-band depending on a number of bits which can be allocated for the encoded bit stream.

3. An encoder according to claim 2, wherein when for a plurality of quantization coefficients, the resultant value of quantization is equal to the expected value of quantization, the quantization coefficient determination portion selects one of the plurality of quantization coefficients so as to obtain a minimum of quantization noise, and determines the selected quantization coefficient as a quantization coefficient for the specific sub-band.

4. An encoder according to claim 3, wherein the quantization noise is calculated based on a difference between the selected one spectral data contained in the specific sub-band and an inverse quantization value obtained by inversely quantizing the resultant value of quantization.

5. An encoder according to claim 3, wherein the quantization noise is calculated based on a difference between each spectral data contained in the specific sub-band and an inverse quantization value obtained by inversely quantizing a result of quantization of each spectral data in the specific sub-band.

6. An encoder according to claim 2, wherein the selected one spectral data is the largest spectral data contained in the specific sub-band.

7. An encoder according to claim 1,
wherein the quantization portion determines the quantization coefficient for the specific sub-band based on a predetermined relationship among a quantization coefficient, a resultant value of quantization, and an inverse quantization value, and based on the relationship, quantizes each of the plurality of spectral data contained in the specific sub-band using the quantization coefficient for the specific sub-band, and
the quantization coefficient for the specific sub-band is determined so that an inverse quantization value obtained by inversely quantizing the expected value of quantization for the specific sub-band using the quantization coefficient for the specific sub-band is substantially equal to the selected one spectral data.

8. An encoder according to claim 7, wherein the predetermined relationship is defined in a first inverse quantization value table defining a relationship between a quantization coefficient and an inverse quantization value when a resultant value of quantization is predetermined, and a second inverse quantization value table defining a relationship between a resultant value of quantization and an inverse quantization value when a quantization coefficient is predetermined.

9. An encoder according to claim 8, wherein the quantization portion generates, based on the first and second inverse quantization value tables, a relationship between a quantization coefficient and an inverse quantization value when a resultant value of quantization is different from the predetermined resultant value of quantization, or a relationship between a resultant value of quantization and an inverse quantization value when a quantization coefficient is different from the predetermined quantization coefficient.

10. An encoder according to claim 8, wherein an inverse quantization value on the first inverse quantization value table is represented by an inverse of said inverse quantization value.

11. An encoder according to claim 8, wherein an inverse quantization value on the second inverse quantization value table is represented by an inverse of said inverse quantization value.

12. An encoder according to claim 7, wherein the expected-value-of-quantization adjustment portion determines the expected value of quantization for the specific sub-band based on the plurality of spectral data contained in the specific sub-band.

13. An encoder according to claim 7, wherein the expected-value-of quantization adjustment portion sets the expected value of quantization for the specific sub-band to a predetermined value.

14. An encoder according to claim 7, wherein the quantization coefficient for the specific sub-band is determined so that an inverse quantization value obtained by inversely quantizing the expected value of quantization for the specific sub-band using the quantization coefficient for the specific sub-band is not smaller than the selected one spectral data.

15. An encoder according to claim 7, wherein the quantization coefficient for the specific sub-band is determined so that an inverse quantization value obtained by inversely quantizing the expected value of quantization for the specific sub-band using the quantization coefficient for the specific sub-band is not greater than the selected one spectral data.

16. An encoder according to claim 7, wherein the quantization coefficient for the specific sub-band is selected from first and second quantization coefficients based on a predetermined condition, an inverse quantization value obtained by inversely quantizing the expected value of quantization for the specific sub-band using the first quantization coefficient for the specific sub-band is not greater than the selected one spectral data, and an inverse quantization value obtained by inversely quantizing the expected value of quantization for the specific sub-band using the second quantization coefficient for the specific sub-band is not smaller than the selected one spectral data.

17. An encoder comprising:
an input device for sampling an input signal at predetermined time intervals to obtain sampled data on a temporal axis;
a conversion device for converting the sampled data on a temporal axis to spectral data on a frequency axis;
a quantization device for quantizing the spectral data on the frequency axis; and
an output device for outputting a resultant value of quantization as an encoded bit stream,
wherein the quantization device comprises:
a quantization coefficient adjustment portion for determining a quantization coefficient for a specific sub-band on the frequency axis; and
a quantization portion for determining a resultant value of quantization for each of the plurality of spectral data contained in the specific sub-band, based on a predetermined relationship between a quantization coefficient, a resultant value of quantization, and an inverse quantization value.

18. An encoder according to claim 17, wherein the predetermined relationship is defined in a first inverse quantization value table defining a relationship between a quantization coefficient and an inverse quantization value when a resultant value of quantization is predetermined, and a second inverse quantization value table defining a relationship between a resultant value of quantization and an inverse quantization value when a quantization coefficient is predetermined.

19. An encoder according to claim 18, wherein the quantization portion generates, based on the first and second inverse quantization value tables, a relationship between a quantization coefficient and an inverse quantization value when a resultant value of quantization is different from the predetermined resultant value of quantization, or a relationship between a resultant value of quantization and an inverse quantization value when a quantization coefficient is different from the predetermined quantization coefficient.

20. An encoder according to claim 18, wherein an inverse quantization value on the first inverse quantization value table is represented by an inverse of said inverse quantization value.

21. An encoder according to claim 18, wherein an inverse quantization value on the second inverse quantization value table is represented by an inverse of said inverse quantization value.

22. An encoder according to claim 17, wherein a resultant value of quantization for each of the plurality of spectral data contained in the specific sub-band is determined so that an inverse quantization value obtained by inversely quantizing the resultant value of quantization for each of the plurality of spectral data contained in the specific sub-band, using the quantization cofficient for the specific sub-band, is substantially equal to the each of the plurality of spectral data contained in the specific sub-band.

23. An encoder according to claim 22, wherein a resultant value of quantization for each of the plurality of spectral data contained in the specific sub-band is determined so that an inverse quantization value obtained by inversely quantizing the resultant value of quantization for each of the plurality of spectral data, using the quantization cofficient for the specific sub-band, is not smaller than the each of the plurality of spectral data.

24. An encoder according to claim 22, wherein a resultant value of quantization for each of the plurality of spectral data contained in the specific sub-band is determined so that an inverse quantization value obtained by inversely quantizing the resultant value of quantization for each of the plurality of spectral data, using the quantization cofficient for the specific sub-band, is not greater than the each of the plurality of spectral data.

25. An encoder according to claim 22, wherein the resultant value of quantization for a specific spectral data of the plurality of spectral data contained in the specific sub-band is selected from first and second resultant values of quantization based on a predetermined condition, an inverse quantization value obtained by inversely quantizing the first resultant value of quantization using the quantization coefficient for the specific sub-band is not greater than the specific spectral data, and an inverse quantization value obtained by inversely quantizing the second resultant value of quantization using the quantization coefficient for the specific sub-band is not smaller than the specific spectral data.

26. An encoder comprising:
an input device for sampling an input signal at predetermined time intervals to obtain sampled data on a temporal axis;
a conversion device for converting the sampled data on the temporal axis to spectral data on a frequency axis;
a quantization device for quantizing the spectral data on the frequency axis; and
an output device for outputting a resultant value of quantization as an encoded bit stream,
wherein the quantization device comprises:
an expected-value-of-quantization adjustment portion for determining an expected value of quantization for a specific sub-band on the frequency axis; and
a first quantization portion for determining an initial value of a quantization coefficient for the specific sub-band, based on a predetermined relationship among a quantization coefficient, a resultant value of quantization, and an inverse quantization value;
a quantization coefficient adjustment portion for determining the quantization coefficient for the specific sub-band; and
a second quantization portion for quantizing each of the plurality of spectral data contained in the sepcific sub-band using the quantization coefficient for the specific sub-band, and
the first quantization portion determines the initial value of the quantization coefficient so that a resultant value of quantization obtained by quantizing one spectral data selected from the plurality of spectral data contained in the specific sub-band, using the initial value for the specific sub-band, is substantially equal to the expected value of quantization for the specific sub-band, and
the quantization coefficient adjustment portion adjusts the quantization coefficient for the specific sub-band so that quantization noise is not greater than qantization noise which is obtained when each of the plurality of spectral data contained in the specific sub-band is quantized using the initial value.

27. An encoder according to claim 26, wherein the second quantization portion quantizes each of the plurality of spectral data contained in the specific sub-band using the quantization coefficient for the specific sub-band, based on a predetermined relationship among a quantization coefficient, a resultant value of quantization, and an inverse quantization value.

28. An encoder according to claim 26, wherein the predetermined relationship is defined in a first inverse quantization value table defining a relationship between a quantization coefficient and an inverse quantization value when a resultant value of quantization is predetermined, and a second inverse quantization value table defining a relationship between a resultant value of quantization and an inverse quantization value when a quantization coefficient is predetermined.

29. An encoder according to claim 28, wherein the first quantization portion generates, based on the first and second inverse quantization value tables, a relationship between a quantization coefficient and an inverse quantization value when a resultant value of quantization is different from the predetermined resultant value of quantization, or a relationship between a resultant value of quantization and an inverse quantization value when a quantization coefficient is different from the predetermined quantization coefficient.

30. An encoder according to claim 26, wherein the expected-value-of-quantization adjustment portion determines the expected value of quantization for the specific sub-band based on the plurality of spectral data contained in the specific sub-band.

31. An encoder according to claim 26, wherein the expected-value-of-quantization adjustment portion sets the expected value of quantization for the specific sub-band to a predetermined value.

32. A program for causing a computer to executing an encoding process for outputting an input signal as an encoded bit stream, the encoding process comprising the steps of:
(a) sampling an input signal at predetermined time intervals to obtain sampled data on a temporal axis;
(b) converting the sampled data on the temporal axis to spectral data on a frequency axis;
(c) quantizing the spectral data on the frequency axis; and
(d) outputting a resultant value of quantization as an encoded bit stream,
wherein the step (c) comprises:
(c-1) determining an expected value of quantization for a specific sub-band on the frequency axis; and
(c-2) determining a quantization coefficient for the specific sub-band, and quantizing each of a plurality of spectral data contained in the specific sub-band using the quantization coefficient for the specific sub-band, and
the step (c-2) comprises the step of determining the quantization coefficient for the specific sub-band so that a resultant value of quantization obtained by quantizing one spectral data selected from the plurality of spectral data contained in the specific sub-band, using the quantization coefficient for the specific sub-band, is substantially equal to the expected value of quantization for the specific sub-band.

33. A computer-readable recording medium for storing an encoding process program for outputting an input signal as an encoded bit stream, the encoding process comprising the steps of:
(a) sampling an input signal at predetermined time intervals to obtain sampled data on a temporal axis;
(b) converting the sampled data on the temporal axis to spectral data on a frequency axis;
(c) quantizing the spectral data on the frequency axis; and
(d) outputting a resultant value of quantization as an encoded bit stream,
wherein the step (c) comprises:
(c-1) determining an expected value of quantization for a specific sub-band on the frequency axis; and
(c-2) determining a quantization coefficient for the specific sub-band, and quantizing each of a plurality of spectral data contained in the specific sub-band using the quantization coefficient for the specific sub-band, and
the step (c-2) comprises the step of determining the quantization coefficient for the specific sub-band so that a resultant value of quantization obtained by quantizing one spectral data selected from the plurality of spectral data contained in the specific sub-band, using the quantization coefficient for the specific sub-band, is substantially equal to the expected value of quantization for the specific sub-band.

34. A communication device comprising:
a demodulator for obtaining digital audio data by demodulating an input signal;
an encoder for obtaining an encoded bit stream by encoding the digital audio data; and
a recorder for recording the encoded bit stream into a recording medium,
wherein the encoder comprises:
an input device for sampling the digital audio data at predetermined time intervals;
a conversion device for converting the sampled data on the temporal axis to spectral data on the frequency axis;
a quantization device for quantizing the spectral data on the frequency axis; and
an output device for outputting a resultant value of quantization as the encoded bit stream,
wherein the quantization device comprises:
an expected-value-of-quantization adjustment portion for determining an expected value of quantization for a specific sub-band on the frequency axis; and
a quantization portion for determining a quantization coefficient for the specific sub-band, and quantizing each of a plurality of spectral data contained in the specific sub-band using the quantization coefficient for the specific sub-band, and
the quantization coefficient for the specific sub-band is determined so that a resultant value of quantization obtained by quantizing one spectral data selected from the plurality of spectral data contained in the specific sub-band, using the quantization coefficient for the specific sub-band, is substantially equal to the expected value of quantization for the specific sub-band.
